(19) United States
(12) Patent Application Publication
(10) Pub. No.: US 2025/0220552 A1
(43) Pub. Date: Jul. 3, 2025

(54) REDUCED ON-DEMAND AND STANDING PRIVILEGE ACCESS CONTROL ASSIGNMENT RECOMMENDATIONS IN MULTI-CLOUD ENVIRONMENTS

(71) Applicant: Microsoft Technology Licensing, LLC, Redmond, WA (US)

(72) Inventors: Shaun Robert APPLEGATE-SWANSON, Austin, TX (US); Andrew Thomas NABER, Redmond, WA (US); Chirag DAYANI, Irvine, CA (US); Sateesh PRAGALLAPATI, Bothell, WA (US); Naga Venkata Naveen Teja JANGALAPALLI, San Jose, CA (US); Avik SETHIA, San Jose, CA (US); Balaji PARIMI, Sunnyvale, CA (US); Rahul PRAKASH, Alameda, CA (US); Maya NEELAKANDHAN, Sunnyvale, CA (US)

(21) Appl. No.: 18/400,818

(22) Filed: Dec. 29, 2023

(51) Int. Cl. H04W 48/02; H04W 48/16

(52) U.S. Cl. CPC H04W 48/02; H04W 48/16

(57) ABSTRACT

Systems, methods, apparatuses, and computer program products are disclosed for determining a set of recommended access control assignments in single-cloud or multi-cloud environments based on historical usage. Paired activity data, representing task and resource pairs associated with an identity, is determined from historical activity data. Over-privileging costs are determined for a set of candidate access control assignments based on the permitted tasks and resource scopes granted by the candidate access control assignments and the paired activity data. A set of recommended access control assignments is determined as a subset of the candidate access control assignments with a lowest aggregate over-privileging cost whose combined permissions and resource scopes cover at least a predetermined percentage of the paired activity data. A recommendation including on-demand and/or standing privilege access control assignments is generated based on the set of recommended access control assignments. A responsive action may be performed based on the recommendation.

### BACKGROUND

Entities, whether human users or software programs, are frequently granted access to permissions beyond what are necessary for their intended tasks or responsibilities. Over-privileging, whether the result of improper access control management, disparate system complexity, the lack of proper processes, mergers and acquisitions, or other causes, may increase the vulnerability of a system to security threats. Proper access management and adhering to the principle of least privilege (PoLP) help mitigate the risks associated with over-privileging. Under PoLP, individual users and/or software programs are granted the minimum level of access or permissions necessary to perform their required tasks, thereby reducing the potential for unauthorized or excessive access and minimizing the risk of security breaches.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems, methods, apparatuses, and computer program products are disclosed for determining a set of recommended access control assignments based on historical usage. Paired activity data, representing task and resource pairs associated with an identity, is determined from historical activity data. Over-privileging costs are determined for a set of candidate access control assignments based on the permitted tasks and resource scopes granted by the candidate access control assignments in comparison to the paired activity data. A set of recommended access control assignments is determined as a subset of the candidate access control assignments with a lowest aggregate over-privileging cost whose combined permissions and resource scopes cover at least a predetermined percentage of the paired activity data. Based on the set of recommended access control assignments, a recommendation is generated that recommends, for a particular candidate access control assignment, at least one of: excepting the particular candidate access control assignment from being assigned to the identity, assigning the particular candidate access control assignment to the identity on a permanent basis, or assigning the particular candidate access control assignment to the identity on an on-demand basis. A responsive action may be performed based on the recommendation.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example system for determining a reduced privilege access control assignment recommendation, in accordance with an example embodiment.

FIG. 2 shows a block diagram of an example system for determining a reduced privilege access control assignment recommendation based on a weighted covering solution, in accordance with an embodiment.

FIG. 3 depicts a flowchart of a process for determining a set of recommended access control assignments, in accordance with an embodiment.

FIG. 4 depicts a flowchart of an example process for determining over-privileging costs associated with candidate access control assignments assigned on a permanent basis, in accordance with an embodiment.

FIG. 5 depicts a flowchart of an example process for determining over-privileging costs associated with candidate access control assignments assigned on an on-demand basis, in accordance with an embodiment.

FIG. 6 depicts a flowchart of an example process for determining an over-privileging reduction metric, in accordance with an embodiment.

FIG. 7 depicts an example graphical user interface (GUI) for displaying analytical data associated with replacing a set of current access control assignments with a set of recommended access control assignments, in accordance with an embodiment.

FIG. 8 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

As used herein, the term “access control assignment” includes permission assignments that may be granted to an identity to grant the identity a set of permitted tasks, and a resource scope that identifies resources and/or resource groups on which the identity may perform the set of tasks. In embodiments, an access control assignment may include a role and/or user group that specifies a set of tasks that may be performed by an identity that is assigned the role and/or user group, and a resource scope assignment that identifies the resources and/or resource groups on which the tasks may be performed. In embodiments, an access control assignment may include a policy that specifies a set of tasks that may be performed by an identity and the resources and/or resource groups that the tasks may be performed on.

As used herein, the term “permanent basis” may refer to access control assignments assigned to an identity on an on-going basis (e.g., until expressly revoked) to allow the identity to perform permitted tasks at any time and/or frequency. In embodiments, access control assignments assigned on a permanent basis may be monitored at a low level of scrutiny.

As used herein, the term “on-demand basis” may refer to access control assignments assigned to an identity on an on-demand basis to allow the identity to perform permitted tasks under one or more certain limitations, such as, but not limited to, time limitation (e.g., time of day/month/year, etc.), periodicity or seasonality limitation (e.g., one day per month/quarter/year, etc.), frequency limitation (e.g., once a day/month/quarter, etc.), data size (e.g., 1 million rows per day/month, etc.), supervision limitation (e.g., alert/notify an administrator and/or supervisor, create a log entry, etc.), historical similarity limitation (e.g., tasks satisfying a similarity threshold to historical activity associated with the identity and/or similar identities, etc.), and/or the like.

As used herein, the term “identity” may include an identifier associated with a human user (e.g., user identifier), a group of users (e.g., user group identifier), and/or a machine (e.g., application identifier, service identifier, bot identifier, etc.), such as a unique numerical code, an alphanumeric code, a two-dimensional code (e.g., QR code) or other identifier type.

As used herein, the term “full-axes” may include two-dimensional matrix representations with axes that include all possible tasks in a cloud platform and/or a multi-cloud environment and all resources associated with a customer of the cloud platform and/or the multi-cloud environment.

As used herein, the term “active-axes” may include two-dimensional matrix representations with axes that include active tasks and active resources that an identity or set of identities has acted upon in a predetermined time period.

### II. Example Embodiments

Determining an appropriate level of access for an identity can be complex and time-consuming due to balancing of tradeoffs. For instance, granting an identity lesser access may lower the risk of security breaches, but granting insufficient access may result in an unintended denial of access when the identity needs to perform a required task. On the other hand, granting an identity greater access will allow the identity to work in an unconstrained manner by allowing the identity to perform tasks without encountering a denial of access, but granting too much access may unnecessarily increase the risk of security breaches. The complexity associated with right-sizing access has led some entities (e.g., customers) to permanently assign roles and/or policies with higher permissions than what is necessary for an identity to perform its tasks.

The complexity associated with right-sizing access increases when managing identities in a multi-cloud environment. In a multi-cloud environment, access control is determined by access control assignments assigned to an identity across multiple cloud platforms. Determining an appropriate level of access for an identity in a multi-cloud environment may involve analyzing access control assignments and historical activity data in a plurality of cloud platforms.

Embodiments disclosed herein are directed to a multi-state approach to reduced (e.g., least) privilege access control assignment recommendations based on historical activity of the identity. In an embodiment, each candidate access control assignment is placed, based on historical activity of the identity, into one of three states: (1) except the particular candidate access control assignment from being assigned to the identity; (2) assign the particular candidate access control assignment to the identity on a permanent basis; or (3) assign the particular candidate access control assignment to the identity on an on-demand basis. Following this 3-state approach, a resultant recommendation may include a set of access control assignments that minimize a degree of over-privileging. In embodiments, the multi-state approach may be applied to a multi-cloud environment to provide reduced (e.g., least) privilege access control assignment recommendations for identities across as plurality of cloud platforms of a multi-cloud environment. In embodiments, the set of recommended access control assignments may be determined based on a weighted covering solution, and may, in embodiments, further specify whether each recommended access control assignment should be assigned on a permanent basis or an on-demand basis.

Historical activity of an identity may, in embodiments, be analyzed to determine for the identity actual usage of current access control assignments currently assigned to the identity. For instance, historical activity of an identity may include, but is not limited to, tasks identifiers (e.g., create, read, update, delete, etc.) identifying tasks performed by the identity, the resource identifiers (e.g., filename, resource group identifier, etc.) identifying resources and/or resource groups that the tasks were performed on, and/or the cloud platform on which the task was performed on. In embodiments, historical activity of an identity may also be associated with temporal information (e.g., timestamp, frequency, rate, etc.) that may be used to determine frequencies and/or patterns in the historical activity.

Based on historical activity of an identity or a set of identities, right-sized access control assignments are recommended to one or more identities to allow the one or more identities to perform its required tasks while minimizing an over-privileging cost metric. In embodiments, the historical activity may include historical activity associated with the identity or set of identities across a plurality of cloud platforms in a multi-cloud environment, and the recommendation may include recommended access control assignments for one or more cloud platforms in the multi-cloud environment.

In embodiments, access control assignments can be assigned to an identity on a permanent basis or an on-demand basis. Access control assignments assigned on a permanent basis may, in embodiments, allow an identity to perform the tasks permitted by the access control assignments on resources associated with the access control assignment at any time. Access control assignments granted on an on-demand basis may, in embodiments, allow the identity to perform the tasks permitted by the access control assignments on resources associated with the access control assignment in a more limited fashion. For instance, the performance of the tasks permitted by the access control assignments on resources associated with the access control assignment may be limited by a time constraint (e.g., monthly, one day per quarter, weekdays only, etc.), a geographical constraint (e.g., while connected to a particular network, at the office, in the country, etc.), a supervision constraint (e.g., alert to an administrator and/or supervisor, logging the actions of the identity, prompting an administrator and/or supervisor for approval, etc.), and/or a historical usage constraint (e.g., tasks that satisfy a similarity threshold with historical activity).

In embodiments, historical activity of an identity may be analyzed to determine patterns in the usage of current access control assignments currently assigned to the identity. For instance, temporal information associated with the historical activity may be analyzed to determine a frequency (e.g., rate, etc.) periodicity (e.g., weekly, monthly, etc.) and/or seasonality (e.g., holidays, etc.) of tasks performed by the identity. Right-sized access control assignments assigned on an on-demand basis may allow an identity to perform tasks that conform to its historical activity. For instance, an identity that performs the same task (e.g., report generation, payroll, etc.) on a periodic basis (e.g., monthly, quarterly, etc.) may be assigned the right-sized access control assignments on an on-demand basis that allows the identity to continue to perform its periodic tasks. In embodiments, access control assignments may, in embodiments, be recommended on an on-demand basis based on frequencies and/or patterns identified in historical activity of the identity.

Current access control assignments of an identity may, in embodiments, be organized into current representations, such as, but not limited to, a matrix and/or any other data structure. For instance, a current access control assignment may be organized into a two-dimensional full-axes current permissions matrix, where a first dimension represents all possible tasks in the cloud platform and/or the multi-cloud environment and a second dimension represents the resources associated with a customer of the identity. In the two-dimensional current permissions matrix, each element represents a task and resource pair. In embodiments, the elements of the current permissions matrix are populated with Boolean values to indicate whether a particular task and resource pair is permitted by the current access control assignment. In embodiments, when the currently assigned access control assignments do not permit a particular task to be permitted on a particular resource, the element associated with particular task and particular resource pair in the current permissions matrix would have a Boolean value of FALSE or zero (“0”). In embodiments, an aggregate current representation may be determined for the current access control assignments currently assigned to an identity by horizontally or vertically concatenating resultant vectors obtained by flattening the current permissions matrices associated with the current access control assignments. In embodiments, a current permissions matrix may be flattened into a resultant vector through various operations, such as, but not limited to, vectorization. In embodiments, the vectorization of a current permissions matrix may include stacking the columns or rows of the current permissions matrix on top of one another. After flattening the current permissions matrices, the resultant vectors may be horizontally or vertically concatenated to arrive at the aggregate current representation.

Historical activity of an identity or a set of identities may, in embodiments, be organized into a historical representation, such as, but not limited to, a matrix and/or any other data structure. For instance, historical activity may be organized into a two-dimensional active-axes historical matrix, where a first dimension represents the active tasks performed by the identity or set of identities and a second dimension represents the active resources on which the tasks were performed. In the two-dimensional historical matrix, each element represents a task and resource pair. In embodiments, the elements of the historical matrix are populated with Boolean values to indicate whether a particular task and resource pair occurs in the historical activity data. For instance, a historical matrix H∈R^{m×n}, where the entries in the historical matrix may be represented by:

$${H}_{ij} = \{ \begin{matrix}1 & task j was performed on resource i in the last z days \\ 0 & otherwise\end{matrix} , \qquad ( Eq . 1 )$$

where m is a positive number representing the number of resources in the active-axes historical matrix, n is a positive number representing the number of tasks in the active-axes historical matrix, and z is any positive number. In embodiments, the elements of the historical matrix are populated with numerical values to indicate the number of times a particular task and resource pair occurs in the historical activity data, a frequency at which the particular task and resource pair occurs in the historical activity data, a rate at which the particular task and resource pair occurs in the historical activity data, and/or a weighted value representing a risk associated with the particular task and resource pair. In embodiments, a flattened historic representation may be determined by flattening the historical matrix into a resultant vector. In embodiments, the resultant vector associated with the historical matrix may be generated through various operations, such as, but not limited to, vectorization. In embodiments, the vectorization of the historic matrix may include stacking the columns or rows of the historic matrix on top of one another.

The historical representation may, in embodiments, represent a subset of the historical activity associated with an identity or set of identities. For instance, the historical representation may include historical activity selected and/or filtered based on one or more criteria, such as, but not limited to, a type of task (e.g., create, read, update, delete, etc.), a type of resource (e.g., file type, data type, etc.), a time period (e.g., previous n days/months/quarters/Aprils/Summers/etc.), whether the activity is permitted in a latest record of permissions and/or resource scopes granted to the identity or set of identities, and/or the like.

A reduced privilege access control recommendation may take into consideration a plurality of candidate access control assignments available in a cloud platform and/or a multi-cloud environment. In embodiments, built-in access control assignments available in each of a plurality of cloud platforms in a multi-cloud environment and customer-defined access control assignments available in each of a plurality of cloud platforms in a multi-cloud environment. For instance, a candidate access control assignment may, in embodiments, include one or more of: a built-in role associated with a first cloud platform provider of a multi-cloud environment and a first resource scope, the built-in role associated with a first set of role permissions to perform a first set of tasks on resources associated with the first resource scope; a built-in policy associated with a second cloud platform provider of a multi-cloud environment, the built-in policy associated with a first set of policy permissions to perform a second set of tasks, and a first set of policy resources on which the second set of tasks may be performed; a customer-defined role and a second resource scope, the customer-defined role associated with a second set of role permissions to perform a third set of tasks on resources associated with the second resource scope; or a customer-defined policy associated, the customer-defined policy associated with a second set of policy permissions to perform a fourth set of tasks, and a second set of policy resources on which the fourth set of tasks may be performed.

Candidate access control assignments may, in embodiments, also be organized into candidate representations, such as, but not limited to a matrix and/or any other data structure. For instance, a candidate access control assignment may be organized into a two-dimensional full-axes candidate permissions matrix, and/or a two-dimensional active-axes candidate permissions matrix. In a two-dimensional full-axes candidate permissions matrix, a first dimension represents all possible tasks in the cloud platform and/or the multi-cloud environment and a second dimension represents the resources associated with a customer of the cloud platform and/or the multi-cloud environment. In a two-dimensional active-axes candidate permissions matrix, a first dimension represents the active tasks associated with the identity or set of identities and a second dimension represents the active resources associated with the identity or set of identities. In the full-axes candidate permissions matrix and/or active-axes candidate permissions matrix, each element represents a task and resource pair associated with the candidate access control assignment.

In embodiments, the elements of the full-axes candidate permissions matrix and/or active-axes candidate permissions matrix are populated with Boolean values to indicate whether a particular task and resource pair is permitted by the candidate access control assignment. For instance, the full-axes candidate permissions matrix may be represented by PεR^{M×N}, where the entries in the full-axes candidate permissions matrix may be represented by:

$${P}_{ij} = \{ \begin{matrix}1 & task j can be performed on resource i \\ 0 & otherwise\end{matrix} , \qquad ( Eq . 2 A )$$

where M is a positive number representing the number of resources in the full-axes candidate permissions matrix, N is a positive number representing the number of tasks in the full-axes candidate permissions matrix. Similarly, the active-axes candidate permissions matrix may include p∈R^{m×n}, where the entries in the active-axes candidate permissions matrix may be represented by:

$${p}_{ij} = \{ \begin{matrix}1 & task j can be performed on resource i \\ 0 & otherwise\end{matrix} , \qquad ( Eq . 2 B )$$

where m is a positive number representing the number of resources in the active-axes candidate permissions matrix, n is a positive number representing the number of tasks in the active-axes candidate permissions matrix. In embodiments, when a candidate access control assignment does not permit a particular task to be permitted on a particular resource or when the particular task is not possible on the particular resource, the element associated with particular task and particular resource pair in the candidate permissions matrix would have a Boolean value of FALSE or zero (“0”).

In embodiments, the elements of the full-axes candidate permissions matrix and/or active-axes candidate permissions matrix are populated with weighted values based on one or more factors associated with the task and resource pair, such as, but not limited to: the type of permission granted (e.g., create, read, update, delete, etc.), the type of data (e.g., personally identifiable information (PII), medical data, financial information, large datasets, etc.) associated with the resource and/or resource groups, and/or the like.

In embodiments, an aggregate full-axes candidate representation may be determined for a plurality of candidate access control assignments by horizontally or vertically concatenating resultant vectors obtained by flattening the full-axes candidate permissions matrices associated with the plurality of candidate access control assignments, and an aggregate active-axes candidate representation may be determined for the plurality of candidate access control assignments by horizontally or vertically concatenating resultant vectors obtained by flattening the active-axes candidate permissions matrices associated with the plurality of candidate access control assignments. In embodiments, a full-axes candidate permissions matrix and/or an active-axes candidate permissions matrix may be flattened into a resultant vector through various operations, such as, but not limited to, vectorization. In embodiments, the vectorization of a full-axes candidate permissions matrix and/or an active-axes candidate permissions matrix may include stacking the columns or rows of a full-axes candidate permissions matrix and/or an active-axes candidate permissions matrix, respectively, on top of one another. After flattening a full-axes candidate permissions matrices and/or an active-axes candidate permissions matrices, the resultant vectors may be horizontally or vertically concatenated to arrive at the aggregate full-axes candidate representation and the aggregate active-axes candidate representation, respectively.

In embodiments, access control assignments may be recommended based on a weighted covering solution that includes a subset of candidate access control assignments with a lowest aggregate over-privileging cost whose combined permissions and resource scopes cover at least a percentage (e.g., 95%, 99%, 100%, etc.) of the task and resource pairs in historical representation. In embodiments, the percentage may be provided, configured, and/or modified by a customer. For instance, a weighted covering solution may be determined by selecting a subset of candidate representations (e.g., active-axes candidate permissions matrices) with a lowest aggregate over-privileging cost whose combined permissions and resource scopes cover at least a percentage of the historical representation (e.g., active-axes historical matrix). In embodiments, the weighted covering solution may be represented by x, where x is determined by exactly solving or approximately solving the following weighted covering problem:

$$\begin{matrix}minimize & {c}^{T} x \\ subject to & Ax ≽ b \\ & {x}_{i} ∈ \{ 0 , 1 \} , i = 1 , … , q\end{matrix} , \qquad ( Eq . 3 )$$

where the vector c E R^{q} represents the cost associated with each candidate permissions matrix, A∈R^{mn×q} represents the aggregate candidate representation where each column or row is associated with a candidate access control assignment, the vector b∈R^{mn} represents the flattened historic representation obtained by flattening the historic matrix into a resultant vector, and the Boolean vector x represents the weighted covering solution, where each entry in x is associated with a candidate permissions matrix (a column or row of A). In the representation of the weighted covering problem above in (Eq. 3), the weighted covering solution x covers 100% of the flattened historic representation b. In embodiments, the weighted covering problem of (Eq. 3) may be solved exactly or solved approximately. For instance, the weighted covering problem of (Eq. 3) may, in embodiments, be approximately solved using an approximation algorithm, such as, but not limited to, a constant-factor approximation algorithm, a polynomial-time approximation scheme (PTAS) algorithm, a fully polynomial-time approximation scheme (FPTAS) algorithm, a quasi-polynomial-time approximation scheme (QPTAS) algorithm, etc.).

In embodiments, the weighed covering problem may be modified to generate an approximate weighted covering solution where the weighted covering solution covers at least a percentage of the flattened historic representation b that is less than 100%. For instance, an approximate weighted covering solution may be represented by x, where x is determined by exactly solving or approximately solving the following weighted covering problem:

$$\begin{matrix}minimize & {c}^{T} x \\ subject to & \frac{1}{nnz ( b )} {\sum }_{i = 1}^{mn} max \{ {b}_{i} - {a}_{i}^{T} x , 0 \} \leq t \\ & {x}_{i} ∈ \{ 0 , 1 \} , i = 1 , … , q\end{matrix} , \qquad ( Eq . 4 )$$

where nnz(b) represents the number of non-zero elements in the historical representation b, aᵢ∈R^{q} represents the ith row of the flattened candidate permissions matrix A, bᵢ∈R^{q} represents the ith entry of flattened historic representation b, and t represents the portion of the flattened historic representation b that is not covered by the weighted covering solution. In embodiments, the weighted covering problem of (Eq. 4) may be solved exactly or solved approximately. For instance, the weighted covering problem of (Eq. 4) may, in embodiments, be approximately solved using an approximation algorithm, such as, but not limited to, a constant-factor approximation algorithm, a PTAS algorithm, a FPTAS algorithm, a QPTAS algorithm, etc.).

In the representation of the weighted covering solution above in (Eq. 4), the constraints assess a penalty of 1 for each instance where bᵢ is 1, but is not covered by x (i.e., when aᵢ^{T}x=0). In other words, each instance where bᵢ is 1, but not covered by x would incur the same penalty. However, in embodiments, the weighted covering solution may be determined based other constraints that place a penalty that may vary depending on other factors, such as, but not limited to, the type of task, the type of resource, the frequency of occurrence, and/or the like.

An over-privileging cost associated with each of the candidate access control assignments may, in embodiments, be calculated using a cost function based on various factors, such as, but not limited to: the tasks permitted by the candidate access control assignment, the resources and/or resource groups that the tasks may be performed on, whether the candidate access control assignment will be assigned on a permanent basis or an on-demand basis, the occurrence of task and resource pairs in a historical representation, a frequency of occurrence of task and resource pairs in a historical representation, and/or a pattern of occurrence of task and resource pairs in a historical representation.

For instance, the over-privileging cost associated with a candidate access control assignment that will be assigned on a permanent basis may, in embodiments, be calculated as the number of permitted task and resource pairs associated with the candidate access control assignment that do not occur in historical activity of the identity. In embodiments, the over-privileging cost associated with a candidate access control assignment that will be assigned on an on-demand basis may, in embodiments, be calculated as the number of permitted task and resource pairs associated with the candidate access control assignment and the frequency and/or pattern of occurrence of corresponding task and resource pairs in historical activity of the identity. For instance, the over-privileging cost associated with permitted task and resource pairs may have an inverse relationship to the frequency of occurrence of the task and resource pair in historical activity of the identity. Furthermore, the over-privileging cost associated with a candidate access control assignment may, in embodiments, be weighted based on one or more factors, such as, but not limited to: the type of permission granted (e.g., create, read, update, delete, etc.), the type of data (e.g., personally identifiable information (PII), medical data, financial information, large datasets, etc.) associated with the resource and/or resource groups, and/or the like.

Reduced privilege access control assignment recommendations may, in embodiments, specify whether a recommended access control assignment should be assigned to an identity on a permanent basis or an on-demand basis. In embodiments, whether a recommended access control assignment should be assigned to an identity on a permanent basis or an on-demand basis may be determined by the weighted covering solution (i.e., one-step solution) by considering candidate access control assignments based both a permanent-basis over-privileging cost that is based on the occurrence of task and resource pairs in the historical representation, and an on-demand-basis over-privileging cost that is based on the frequency and/or pattern of occurrence of task and resource pairs in the historical representation. As such, the inclusion of a candidate access control assignment in the weighted covering solution may be based on the permanent-basis over-privileging cost or the on-demand-basis over-privileging cost, depending on which over-privileging cost results in a lower aggregate over-privileging cost for the weighted covering solution. In embodiments, a candidate access control assignment selected based on its permanent-basis over-privileging cost would be recommended on a permanent basis, and a candidate access control assignment selected based on its on-demand-basis over-privileging cost would be recommended on an on-demand basis.

In embodiments, the permanent-basis over-privileging costs and the on-demand-basis privileging costs associated with the candidate access control assignments may be represented by a new cost matrix:

$$C = [ \begin{matrix}{c}_{1} & {c}_{2}\end{matrix} ] ∈ {R}^{q \times 2} , \qquad ( Eq . 5 )$$

where the column c₁∈R^{q} represents the permanent-basis over-privileging costs associated with selecting each candidate access control assignment on a permanent basis, and the column c₂∈R^{q} represents the on-demand-basis over-privileging costs associated with selecting each candidate access control assignment on an on-demand basis. Based on this new cost matrix, the representation of the weighted covering problem above in (Eq. 3), becomes:

$$\begin{matrix}minimize & tr ( {C}^{T} X ) \\ subject to & AX 1 ≽ b \\ & {X}_{ij} ∈ \{ 0 , 1 \} , i = 1 , … , q and j = 1 , 2 \\ & X 1 ≼ 1\end{matrix} , \qquad ( Eq . 6 )$$

where the decision variable X∈{0, 1}^{q×2} is obtained by exactly solving or approximately solving the weighted covering problem in (Eq. 6), and represents the ternary solution in its rows. For instance, if a row of the q×2 matrix X has a value of [0 0], the candidate access control assignment associated with the row is not selected as part of the weighted covering solution. If a row of the q×2 matrix X has a value of [1 0], the candidate access control assignment associated with the row has been selected as part of the weighted covering solution on a permanent basis. If a row of the q×2 matrix X has a value of [0 1], the candidate access control assignment associated with the row has been selected as part of the weighted covering solution on an on-demand basis. Given the final constraint above, X1≤1, no row of the q×2 matrix X can have a value of [1 1]. In embodiments, the weighted covering problem of (Eq. 6) may be solved exactly or solved approximately. For instance, the weighted covering problem of (Eq. 6) may, in embodiments, be approximately solved using an approximation algorithm, such as, but not limited to, a constant-factor approximation algorithm, a PTAS algorithm, a FPTAS algorithm, a QPTAS algorithm, etc.).

In embodiments, whether a recommended access control assignment should be assigned to an identity on a permanent basis or an on-demand basis may be determined after a set of recommended access control assignments are determined. Under a two-step heuristic approach, the weighted covering problem considers candidate access control assignments only a permanent-basis based on a permanent-basis over-privileging cost that is based on the occurrence of task and resource pairs in the historical representation. Subsequent to selecting a set of recommended access control assignments based on a weighted covering solution, the selected recommended access control assignments are recommended on a permanent basis or an on-demand basis based on the frequency of occurrence (e.g., threshold number of occurrences, rate of occurrence, etc.) and/or pattern of occurrence (e.g., every month/quarter, etc.) of task and resource pairs permitted by the recommended access control assignment in the historical representation.

In embodiments, the weighted covering solution may be determined subject to one or more configurable constraints, such as, but not limited to, a minimum percentage of historical activity of the identity that needs to cover by the weighted covering solution, the maximum number of candidate access control assignments that may be selected for the weighted covering solution, the maximum number of candidate access control assignments that may be selected for the weighted covering solution on a permanent basis, the maximum number of candidate access control assignments that may be selected for the weighted covering solution on an on-demand basis and/or the like. For instance, in the first representation of the weighted covering solution above in (Eq. 3), the maximum number of candidate access control assignments that may be selected for the weighted covering solution may be indicated by the constraint Σᵢ₌₁^{q}xᵢ≤s, where s represents the maximum number of candidate access control assignments that may be selected for the weighted covering solution. In the second representation of the weighted covering solution above in (Eq. 6), the maximum number of candidate access control assignments that may be selected for the weighted covering solution may be indicated by the constraint

$$\frac{1}{q} {\sum }_{i = 1}^{q} ( {X}_{i , 1} + {X}_{i , 2} ) \leq u ,$$

where u represents the maximum number of candidate access control assignments that may be selected for the weighted covering solution. Furthermore, in the second representation of the weighted covering solution above in (Eq. 6), the maximum number of candidate access control assignments that may be selected for the weighted covering solution on a permanent basis may be indicated by the constraint

$$\frac{1}{q} {\sum }_{i = 1}^{q} ( {X}_{i , 1} ) \leq {u}_{1} ,$$

where u₁ represents the maximum number of candidate access control assignments that may be selected on a permanent basis for the weighted covering solution. Similarly, in the second representation of the weighted covering solution above in (Eq. 5), the maximum number of candidate access control assignments that may be selected for the weighted covering solution on a permanent basis may be indicated by the constraint

$$\frac{1}{q} {\sum }_{i = 1}^{q} ( {X}_{i , 2} ) \leq {u}_{2} ,$$

where u₂ represents the maximum number of candidate access control assignments that may be selected on an on-demand basis for the weighted covering solution.

Various responsive actions may be performed based on the set of recommended access control assignments. In embodiments, a reduced privilege access control assignment recommendation may recommends, for each particular candidate access control assignment of the plurality of candidate access control assignments, at least one of: excepting the particular candidate access control assignment from being assigned to the identity, assigning the particular candidate access control assignment to the identity on a permanent basis, or assigning the particular candidate access control assignment to the identity on an on-demand basis. In embodiments, at least a portion of the reduced privilege access control assignment recommendation may be automatically applied to an identity by reassigning, on a permanent basis, a currently assigned access control assignment on an on-demand basis, by reassigning, on an on-demand basis, a currently assigned access control assignment on an permanent basis, and/or by replacing some or all of the current access control assignments of the identity with at least a portion of the set of recommended access control assignments. In embodiments, the reduced privilege access control assignment recommendation may be applied to an identity in stages. For instance, in an initial stage, unused or infrequently used current access control assignments may be transitioned from a permanent basis to an on-demand basis. After a period of time (e.g., 3 months, 1 year, etc.) has elapsed, in a second stage, the current access control assignments that were transitioned the first stage may, in embodiments, be unassigned from the identity if they were not used by the identity during the elapsed period of time.

In embodiments, the reduced privilege access control assignment recommendation may be provided to a customer with an option for the customer to approve implementation of the reduced privilege access control assignment recommendation. For instance, the reduced privilege access control assignment recommendation may, in embodiments, be provided to the customer via a communication (e.g., email, notification, alert, etc.) and/or via a user interface (e.g., GUI, etc.). The reduced privilege access control assignment recommendation may, in embodiments, include customer selectable elements (e.g., hyperlink, button, GUI element, etc.) to allow the customer to approve some or all of the reduced privilege access control assignment recommendation.

The reduced privilege access control assignment recommendation may, in embodiments, include analytical data to encourage the customer to implement the set of recommended access control assignments. In embodiments, the analytical data may include, but is not limited to, infographics, charts, graphs, numbers, text, and/or the like to allow the customer to visualize an amount of over-privileging reduction associated with implementation of the reduced privilege access control assignment recommendation. In embodiments, the amount of over-privileging reduction may be determined based on an over-privileging reduction metric represented by:

$$\frac{( {\sum }_{current} - {\sum }_{recommended} )}{{\sum }_{current}} , \qquad ( Eq . 7 )$$

where Σ_{current} represents an aggregate over-privileging cost associated with current access control assignments currently assigned to an identity, and Σ_{recommended} represents an aggregate over-privileging cost associated with the set of recommended access control assignments. In embodiments, Σ_{current} may be determined by comparing the current permissions matrix to the historical matrix to determine task and resource pairs that are permitted by the current access control assignments with a value of zero in the historical matrix. In embodiments, Σ_{recommended} may be determined by comparing the full-axes candidate permissions matrices associated with the set of recommended access control assignments to the historical matrix to determine task and resource pairs that would be permitted by the set of recommended access control assignments with a value of zero in the historical matrix. In embodiments, the over-privileging reduction metric may be displayed to a customer as a percentage.

In embodiments, implementation of the reduced privilege access control assignment recommendation may include a rollback functionality to allow a customer to revert to a previous access control assignment configuration. For instance, a rollback checkpoint may be generated whenever a reduced privilege access control assignment recommendation is implemented, either automatically and/or based on customer approval of the reduced privilege access control assignment recommendation. Such a rollback functionality may ease customer anxiety associated with reducing permissions and/or resource scopes associated with an entity. For instance, if an identity encounters any issues with a newly implemented reduced privilege access control assignment recommendation, the identity simply needs to revert to a previous access control assignment configuration.

These and further embodiments are disclosed herein that enable the functionality described above and further such functionality. Such embodiments are described in further detail as follows.

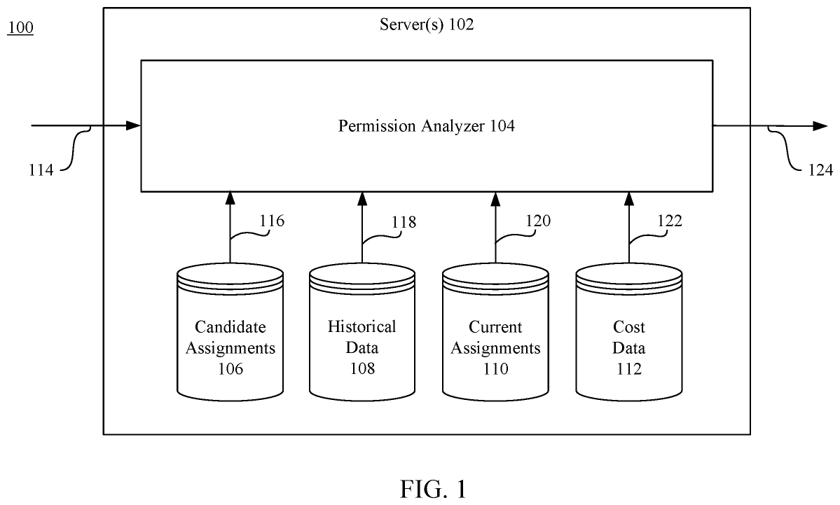

For instance, FIG. 1 shows a block diagram of an example system 100 for determining a reduced privilege access control assignment recommendation, in accordance with an example embodiment. As shown in FIG. 1, system 100 includes one or more servers 102 that include a permission analyzer 104, candidate assignments 106, historical data 108, current assignments 110, and cost data 112. System 100 is described in further detail as follows.

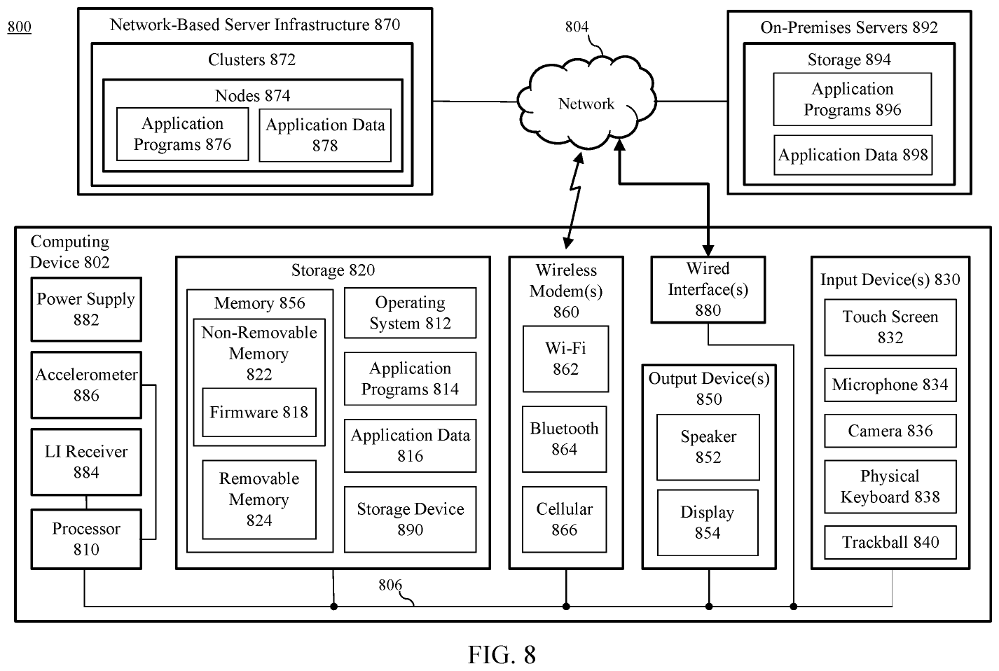

Server(s) 102 may include any computing device suitable for performing functions that are ascribed thereto in the following description, as will be appreciated by persons skilled in the relevant art(s), including those mentioned elsewhere herein or otherwise known. Various example implementations of server(s) 102 are described below in reference to FIG. 8 (e.g., computing device 802, network-based server infrastructure 870, and/or on-premises servers 892).

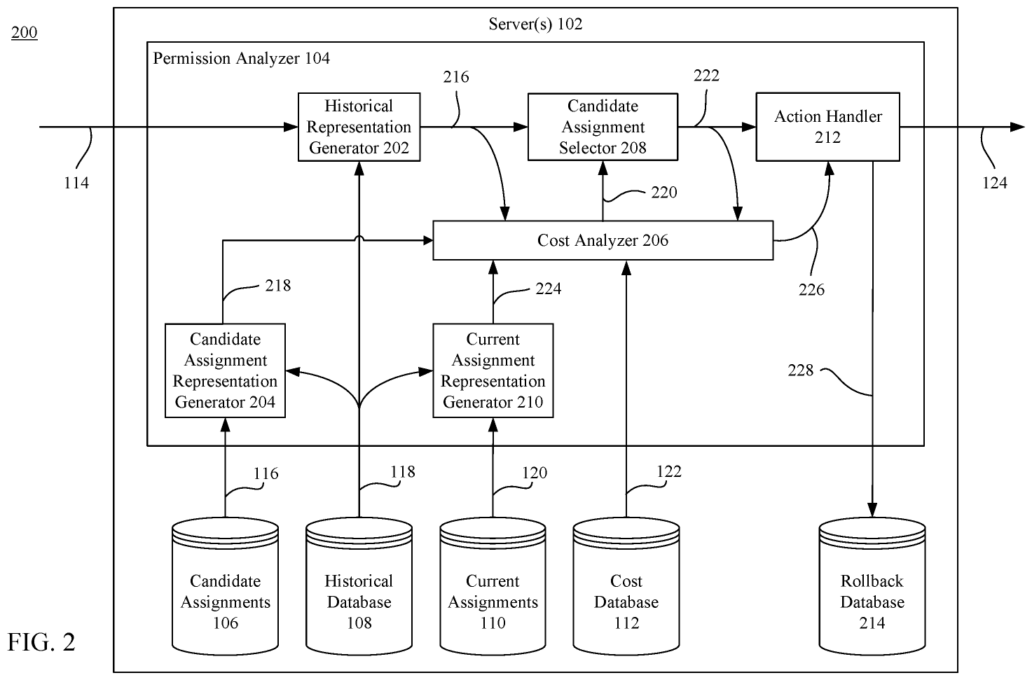

Permission analyzer 104 is configured to receive a set of identities 114 and determine a reduced privilege access control assignment recommendation based on candidate assignments 116 that are available to the set of identities 114, historical data 118 associated with the set of identities 114, current assignments 120 that are currently assigned to the set of identities 114, and cost data 122 associated with permitted tasks and/or resource scopes associated with candidate assignments 116. In embodiments, the set of identities 114 may include identities in one or more cloud platforms of a multi-cloud environment. Based on the determined reduced privilege access control assignment recommendation, permission analyzer 104 is configured to produce an output 124 that may include, but is not limited to, a recommendation provided to a customer, an instruction and/or command to implement the reduced privilege access control assignment recommendation, a GUI provided to a customer, an alert, notification, and/or prompt provided to a customer, a log entry provided to a log, and/or the like. Permission analyzer 104 will be described in greater detail in conjunction with FIG. 2 below.

Candidate assignments database 106 is configured to store one or more candidate access control assignments that are available for assignment to one or more identities. In embodiments, candidate assignments database 106 may include candidate access control assignments that are available in one or more cloud platforms of a multi-cloud environment. In embodiments, access control assignments stored in candidate assignments database 106 may include a role and/or user group that specifies a set of tasks that may be performed by an identity that is assigned the role and/or user group, and a resource scope assignment that identifies the resources and/or resource groups that the tasks may be performed on. In embodiments, access control assignments stored in candidate assignments database 106 may include a policy that specifies a set of tasks that may be performed by an identity and the resources and/or resource groups that the tasks may be performed on. In embodiments, candidate assignments database 106 may return candidate assignments 116 that are available for the set of identities 114 based on a query that includes the set of identities 114.

Historical database 108 is configured to store historical activity data associated with one or more identities in one or more cloud platforms. In embodiments, historical database 108 may store tasks performed by an identity, in conjunction with one or more of: the resource the task was performed on, the temporal information associated with when the task was performed, location information associated with where the identity performed the task from, the cloud platform in which the task was performed, and/or the like. In embodiments, historical database 108 return historical data 118 associated with the set of identities 114 based on a query that includes the set of identities 114.

Current assignments database 110 is configured to store one or more current access control assignments that are currently assigned to one or more identities. In embodiments, current assignments database 110 may include current access control assignments that are currently assigned to one or more identities in one or more cloud platform of a multi-cloud environment. In embodiments, current access control assignments stored in current assignments database 110 may include a role and/or user group that specifies a set of tasks that may be performed by an identity that is assigned the role and/or user group, and a resource scope assignment that identifies the resources and/or resource groups that the tasks may be performed on. In embodiments, current access control assignments stored in candidate assignments database 110 may include a policy that specifies a set of tasks that may be performed by an identity and the resources and/or resource groups that the tasks may be performed on. In embodiments, candidate assignments database 110 may return current assignments 120 that are currently assigned to the set of identities 114 based on a query that includes the set of identities 114.

Cost database 112 is configured to store cost data 122 associated with one or more of: permitted tasks and/or resource scopes associated with candidate assignments 116 stored in candidate assignments database 106, permitted tasks and/or resource scopes associated with current assignments 120 stored in current assignments database 110, and/or the like. In embodiments, cost data 122 stored in cost database 112 may include weighted values based on one or more factors associated with the permitted task and/or resource scope associated with candidate assignments 116 stored in candidate assignments database 106 and/or current assignments 120 stored in current assignments database 110. In embodiments, the weighted values may be determined based on various factors, such as, but not limited to one or more of: the type of permission granted (e.g., create, read, update, delete, etc.), the type of data (e.g., personally identifiable information (PII), medical data, financial information, large datasets, etc.) associated with the resource and/or resource groups, and/or the like. In embodiments, the weighted values may be provided by a customer associated for determining reduced privilege access control assignment recommendations for the customer. In embodiments, the weighted values may be determined by one or more cloud platform providers based on relevant information, such as, but not limited to: information from subject matter experts, analysis of historical security breaches, analysis of detected intrusions, and/or the like.

Embodiments described herein may operate in various ways to determine a reduced privilege access control assignment recommendation. For instance, FIG. 2 shows a block diagram of an example system 200 for determining a reduced privilege access control assignment recommendation based on a weighted covering solution, in accordance with an embodiment. As shown in FIG. 2, system 200 includes server(s) 102, permission analyzer 104, candidate assignments database 106, historical database 108, current assignments database 110, and cost database 112, as shown in FIG. 1. In system 200, server(s) 102 further includes a rollback database 214, and permission analyzer 104 further includes a historical representation generator 202, a candidate assignment representation generator 204, a cost analyzer 206, a candidate assignment selector 208, a current assignment representation generator 210, and an action handler 212. System 200 is described in further detail as follows.

Historical representation generator 202 is configured to receive the set of identities 114, to generate a historical representation 216 based on historical data 118 associated with the set of identities 114 that is retrieved from historical database 108, and to provide historical representation 216 to cost analyzer 206 and candidate assignment selector 208. In embodiments, historical representation 216 may include, but is not limited to, a historic matrix and/or a flattened historic representation, as discussed above. For instance, historical representation 216 may, in embodiments, include a two-dimensional historical matrix, where each element represents a task and resource pair and populated with values to indicate whether a particular task and resource pair occurs in the historical activity data and/or the frequency of occurrence of the particular task and resource pair in the historical activity data. In embodiments, historical representation 216 may include a flattened historic representation determined by vectorization of the historical matrix. In embodiments, historical representation 216 may represent a subset of the historical activity associated with an identity by filtering the historical activity based on one or more criteria.

Candidate assignment representation generator 204 is configured to generate a candidate representation 218 based on candidate assignments 116 associated with the set of identities 114 that are retrieved from candidate assignments database 106 and on historical activity 118 associated with the set of identities 114 that is retrieved from historical database 108, and provide the generated candidate assignment representation 218 to candidate assignment selector 208. In embodiments, candidate representation 218 may include, but is not limited to, one or more full-axes candidate access control assignments, one or more active-axes candidate access control assignments, an aggregate full-axes candidate representation generated based on one or more full-axes candidate access control assignments, and/or an aggregate active-axes candidate representation generated based on one or more active-axes candidate access control assignments, as discussed above.

Cost analyzer 206 is configured to receive historical representation 216 from historical representation generator 202 and candidate assignment representation 218 from candidate representation generator 204, and determine an over-privileging cost for each full-axes candidate access control assignment and/or active-axes access control assignment in candidate assignment representation 218 based on cost data 120 obtained from cost database 110. In embodiments, the over-privileging cost associated with a candidate access control assignment that will be assigned on a permanent basis may be calculated as the number of permitted task and resource pairs associated with the candidate access control assignment that do not occur in historical activity of the identity, and an over-privileging cost associated with a candidate access control assignment that will be assigned on an on-demand basis may be calculated as the number of permitted task and resource pairs associated with the candidate access control assignment and the frequency and/or pattern of occurrence of corresponding task and resource pairs in historical activity of the identity. Furthermore, the over-privileging cost associated with a candidate access control assignment may, in embodiments, be weighted based on one or more factors, such as, but not limited to: the type of permission granted (e.g., create, read, update, delete, etc.), the type of data (e.g., personally identifiable information (PII), medical data, financial information, large datasets, etc.) associated with the resource and/or resource groups, and/or the like. In embodiments, the determined over-privileging costs may include a cost matrix, C=[c₁ c₂]∈R^{q×2}, as discussed in conjunction with (Eq. 5) above. Cost analyzer 206 is further configured to provide, to candidate assignment selector 208, candidate assignment representation 218 and the determined over-privileging costs as candidate assignment data 220.

Candidate assignment selector 208 is configured to receive historical representation 216 from historical representation generator 202, candidate assignment data 220 from cost analyzer 206, and to determine a set of recommended access control assignments 222 as a subset of candidate access control assignments with a lowest aggregate over-privileging cost whose combined permissions and resource scopes cover at least a percentage (e.g., 95%, 99%, 100%, etc.) of the task and resource pairs in historical representation 216. In embodiments, the percentage may be provided and/or modified by a customer. In embodiments, candidate assignment selector 208 may determine recommended access control assignments 222 based on a weighted covering solution, as discussed above in conjunction with (Eq. 3), (Eq. 4), and/or (Eq. 6). In embodiments, the weighted covering solution may be determined subject to one or more customer configurable constraints, such as, but not limited to, a minimum percentage of historical activity of the identity that needs to cover by the weighted covering solution, the maximum number of candidate access control assignments that may be selected for the weighted covering solution, the maximum number of candidate access control assignments that may be selected for the weighted covering solution on a permanent basis, the maximum number of candidate access control assignments that may be selected for the weighted covering solution on an on-demand basis and/or the like. Candidate assignment selector 208 is configured to provide recommended access control assignments 222 to cost analyzer 206 and action handler 212.

Current assignment representation generator 210 is configured to generate a current assignment representation 224 based on current assignments 120 currently assigned to the set of identities 114 that are retrieved from current assignments database 110 and based on historical data 118 associated with the set of identities 114 that is retrieved from historical database 108. In embodiments, current assignment representation 224 may include, but is not limited to, one or more current permissions matrices associated with current access control assignments currently assigned to the set of identities 114, and/or an aggregate current representation generated based on one or more current permissions matrices associated with current access control assignments currently assigned to the set of identities 114. Current assignment representation generator 210 is configured to provide current assignment representation 224 to cost analyzer 206.

Cost analyzer 206 is further configured to receive recommended access control assignments 222 from candidate assignment selector 208 and current assignment representation 224 from current assignment representation generator 210, and to determine an over-privileging reduction metric 226 based on recommended access control assignments 222, current assignment representation 224, and cost data 122. In embodiments, over-privileging reduction metric 226 may be determined as a percentage based on

$$\frac{( {\sum }_{current} - {\sum }_{recommended} )}{{\sum }_{current}} ,$$

as discussed in conjunction with (Eq. 7) above. Cost analyzer 206 may provide over-privileging reduction metric 226 to action handler 212.

Action handler 212 is configured to receive recommended access control assignments 222 from candidate assignment selector 208 and over-privileging reduction metric 226 from cost analyzer 206, and perform one or more responsive actions based on recommended access control assignments 222 and/or over-privileging reduction metric 226. In embodiments, action handler 212 may determine a reduced privilege access control assignment recommendation that indicates, for each particular candidate assignment 106, a recommended assignment state, where the recommended assignment state may include at least one of: excepting the particular candidate assignment 106 from being assigned to one or more identities of the set of identities 114, assigning the particular candidate access control assignment to one or more identities of the set of identities 114 on a permanent basis, or assigning the particular candidate access control assignment to one or more identities of the set of identities 114 on an on-demand basis.

In embodiments, action handler 212 may automatically implement at least a portion of the reduced privilege access control assignment recommendation by reassigning a currently assigned access control assignment on a permanent basis or an on-demand basis, and/or replacing some or all current access control assignments of the identity with at least a portion of the set of recommended access control assignments. In embodiments, action handler 212 may apply the reduced privilege access control assignment recommendation to one or more identities of the set of identities 114 in stages. For instance, in an initial stage, action handler 212 may transition unused or infrequently used current access control assignments from a permanent basis to an on-demand basis. After a period of time has elapsed, in a second stage, action handler 212 may unassign, from the one or more identities of set of identities 114, the current access control assignments that were transitioned the first stage that were not used by the one or more identities of set of identities 114 during the elapsed period of time. In embodiments, action handler 212 may implement the reduced privilege access control assignment recommendation by providing one or more instructions, commands, and/or application programming interface (API) calls to one or more external systems (not depicted) as output 124.

In embodiments, action handler 212 may provide a customer the reduced privilege access control assignment recommendation along with an option for the customer to approve implementation of the reduced privilege access control assignment recommendation. For instance, action handler 212 may provide the reduced privilege access control assignment recommendation may to the customer via a communication (e.g., email, notification, alert, etc.) and/or via a user interface (e.g., GUI, etc.). The reduced privilege access control assignment recommendation may, in embodiments, include customer selectable elements (e.g., hyperlink, button, GUI element, etc.) to allow the customer to approve some or all of the reduced privilege access control assignment recommendation. In embodiments, action handler 212 may further provide analytical data to the customer to encourage the customer to implement the set of recommended access control assignments. In embodiments, the analytical data may include, but is not limited to, infographics, charts, graphs, numbers, text, over-privileging reduction metric 226, and/or the like to allow the customer to visualize an amount of over-privileging reduction associated with implementation of the reduced privilege access control assignment recommendation. In embodiments, action handler 212 may provide the reduced privilege access control assignment recommendation and/or analytical data to a customer device (not depicted) as output 124.

In embodiments, action handler 212 may generate a rollback checkpoint 228 when the reduced privilege access control assignment recommendation is implemented, either automatically and/or based on customer approval of the reduced privilege access control assignment recommendation, and provide rollback checkpoint 228 for storage in rollback database 214.

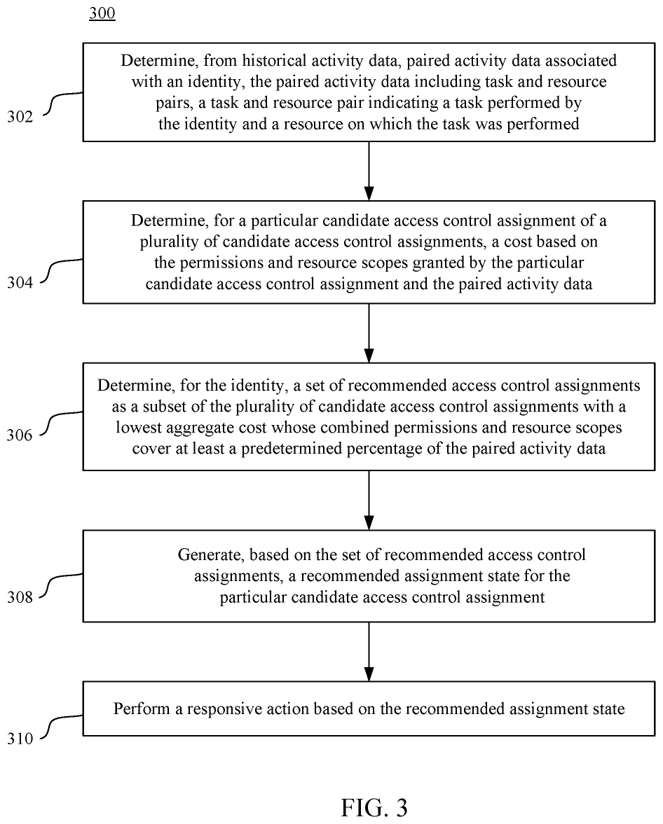

Embodiments described herein may operate in various ways to determine a set of recommended access control assignments. For instance, FIG. 3 depicts a flowchart 300 of a process for determining a set of recommended access control assignments, in accordance with an embodiment. Server(s) 102, permission analyzer 104, candidate assignments database 106, historical database 108, current assignments database 110, cost database 112, historical representation generator 202, candidate assignment representation generator 204, cost analyzer 206, candidate assignment selector 208, current assignment representation generator 210, action handler 212 of FIGS. 1 and/or 2 may operate according to flowchart 300, for example. Note that not all steps of flowchart 300 may need to be performed in all embodiments, and in some embodiments, the steps of flowchart 300 may be performed in different orders than shown. Flowchart 300 is described as follows with respect to FIGS. 1 and 2 for illustrative purposes.

Flowchart 300 starts at step 302. In step 302, paired activity data associated with an identity is determined, from historical activity data, the paired activity data including task and resource pairs, each task and resource pair indicating a task performed by the identity and a resource on which the task was performed. For instance, historical representation generator 202 of permission analyzer 104 may determine historical representation 216 based on historical data 118 associated with the set of identities 114 that is retrieved from historical database 108, and provide historical representation 216 to cost analyzer 206 and candidate assignment selector 208. In embodiments, historical representation 216 may include a two-dimensional historical matrix, where each element represents a task and resource pair and populated with values to indicate whether a particular task and resource pair occurs in the historical activity data and/or the frequency of occurrence of the particular task and resource pair in the historical activity data. In embodiments, historical representation 216 may include a flattened historic representation determined by vectorization of the historical matrix. In embodiments, historical representation 216 may represent a subset of the historical activity associated with an identity by filtering the historical activity based on one or more criteria.

In step 304, a cost is determined for each particular candidate access control assignment of a plurality of candidate access control assignments based on the permitted tasks and resource scopes granted by the particular candidate access control assignment and the paired activity data. For instance, cost analyzer 206 may determine an over-privileging cost for each full-axes candidate access control assignment and/or active-axes access control assignment in candidate assignment representation 218 based on cost data 120 obtained from cost database 110. In embodiments, the over-privileging cost associated with a candidate access control assignment that will be assigned on a permanent basis may be calculated as the number of permitted task and resource pairs associated with the candidate access control assignment that do not occur in historical activity of the identity, and an over-privileging cost associated with a candidate access control assignment that will be assigned on an on-demand basis may be calculated as the number of permitted task and resource pairs associated with the candidate access control assignment and the frequency and/or pattern of occurrence of corresponding task and resource pairs in historical activity of the identity. Cost analyzer 206 is further configured to provide, to candidate assignment selector 208, candidate assignment representation 218 and the determined over-privileging costs as candidate assignment data 220.

In step 306, a set of recommended access control assignments is determined for the identity as a subset of the plurality of candidate access control assignments with a lowest aggregate cost whose combined permissions and resource scopes cover at least a predetermined percentage of the paired activity data. For instance, candidate assignment selector 208 may determine a set of recommended access control assignments 222 as a subset of candidate access control assignments with a lowest aggregate over-privileging cost whose combined permissions and resource scopes cover at least a percentage of the task and resource pairs in historical representation 216. In embodiments, candidate assignment selector 208 may determine recommended access control assignments 222 based on a weighted covering solution, as discussed above in conjunction with (Eq. 3), (Eq. 4), and/or (Eq. 6). Candidate assignment selector 208 is configured to provide recommended access control assignments 222 to action handler 212.

In step 308, a recommendation is generated to recommend, for a particular candidate access control assignment, a recommended assignment state comprising at least one of: excepting the particular candidate access control assignment from being assigned to the identity, assigning the particular candidate access control assignment to the identity on a permanent basis, or assigning the particular candidate access control assignment to the identity on an on-demand basis. For instance, action handler 212 may determine a reduced privilege access control assignment recommendation that indicates, for each particular candidate assignment 106, a recommended assignment state, where the recommended assignment state may include at least one of: excepting the particular candidate assignment 106 from being assigned to one or more identities of the set of identities 114, or assigning the particular candidate access control assignment to one or more identities of the set of identities 114 on a permanent basis, or assigning the particular candidate access control assignment to one or more identities of the set of identities 114 on an on-demand basis.

In step 310, a responsive action is performed based on the recommended assignment state. For instance, action handler 212 may, in embodiments, automatically implement at least a portion of the reduced privilege access control assignment recommendation by reassigning, on a permanent basis, a currently assigned access control assignment on an on-demand basis, by reassigning, on an on-demand basis, a currently assigned access control assignment on a permanent basis, by replacing some or all of the current access control assignments of one or more identities of the set of identities 114 with at least a portion of the set of recommended access control assignments, by applying the reduced privilege access control assignment recommendation to one or more identities of the set of identities 114 in stages, by providing one or more instructions, commands, and/or application programming interface (API) calls to one or more external systems, by providing a customer the reduced privilege access control assignment recommendation along with an option for the customer to approve implementation of the reduced privilege access control assignment recommendation, by providing analytical data to a customer, by generating a rollback checkpoint 228 when the reduced privilege access control assignment recommendation is implemented, either automatically and/or based on customer approval of the reduced privilege access control assignment recommendation, and/or by providing rollback checkpoint 228 for storage in rollback database 214.

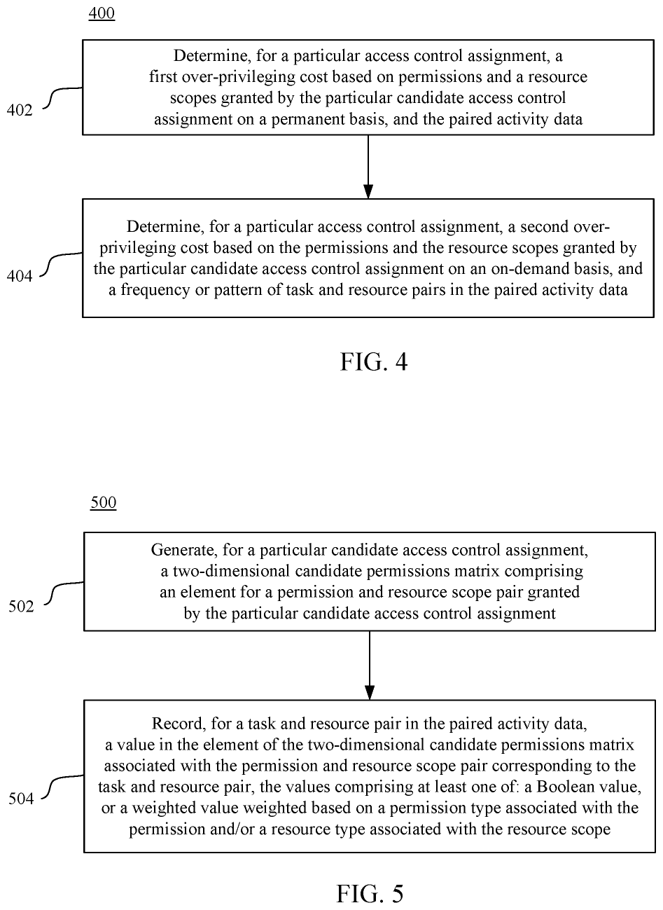

Embodiments described herein may operate in various ways to determine over-privileging costs associated with candidate access control assignments. For instance, FIG. 4 depicts a flowchart 400 of a process for determining over-privileging costs associated with candidate access control assignments assigned on a permanent basis and on an on-demand basis, in accordance with an embodiment. Server(s) 102, permission analyzer 104, candidate assignments database 106, historical database 108, current assignments database 110, cost database 112, and/or cost analyzer 206 of FIGS. 1 and/or 2 may operate according to flowchart 400, for example. Flowchart 400 is described as follows with respect to FIGS. 1 and 2 for illustrative purposes.

Flowchart 400 starts at step 402. In step 402, a first over-privileging cost is determined, for each particular access control assignment based on permissions and a resource scopes granted by the particular candidate access control assignment on a permanent basis, and the paired activity data. For instance, cost analyzer 206 may determine an over-privileging cost associated with a candidate access control assignment that will be assigned on a permanent basis as the number of permitted task and resource pairs associated with the candidate access control assignment that do not occur in historical activity of the identity. In embodiments, cost analyzer 206 may calculate the over-privileging cost on a weighted basis based on one or more factors, such as, but not limited to: the type of permission granted (e.g., create, read, update, delete, etc.), the type of data (e.g., personally identifiable information (PII), medical data, financial information, large datasets, etc.) associated with the resource and/or resource groups, and/or the like.

In step 404, a second over-privileging cost is determined for each particular access control assignment based on the permitted tasks and the resource scopes granted by the particular candidate access control assignment on an on-demand basis, and a frequency or pattern of task and resource pairs in the paired activity data. For instance, cost analyzer 206 may determine an over-privileging cost associated with a candidate access control assignment that will be assigned on an on-demand basis as the number of permitted task and resource pairs associated with the candidate access control assignment and the frequency and/or pattern of occurrence of corresponding task and resource pairs in historical activity of the identity. In embodiments, cost analyzer 206 may calculate the over-privileging cost on a weighted basis based on one or more factors, such as, but not limited to: the type of permission granted (e.g., create, read, update, delete, etc.), the type of data (e.g., personally identifiable information (PII), medical data, financial information, large datasets, etc.) associated with the resource and/or resource groups, and/or the like.

Embodiments described herein may operate in various ways to determine a candidate access control representation. For instance, FIG. 5 depicts a flowchart 500 of a process for determining a candidate access control representation, in accordance with an embodiment. Server(s) 102, permission analyzer 104, candidate assignments database 106, historical database 108, current assignments database 110, cost database 112, candidate assignment representation generator 204, and/or cost analyzer 206, of FIGS. 1 and/or 2 may operate according to flowchart 500, for example. Flowchart 500 is described as follows with respect to FIGS. 1 and 2 for illustrative purposes.

Flowchart 500 starts at step 502. In step 502, a two-dimensional candidate permissions matrix comprising an element for each permission and resource scope pair granted by the particular candidate access control assignment is generated for each particular candidate access control assignment. For instance, candidate assignment representation generator 204 may generate a two-dimensional full-axes candidate permissions matrix and/or a two-dimensional active-axes candidate permissions matrix that each include elements representing a task and resource pair associated with the candidate access control assignment.

In step 504, a value is recorded, for each task and resource pair in the paired activity data, in the element of the two-dimensional candidate permissions matrix associated with a permission and resource scope pair corresponding to the task and resource pair, the value comprising at least one of: a Boolean value, or a weighted value weighted based on a permission type associated with the permission and/or a resource type associated with the resource scope. For instance, candidate assignment representation generator 204 may, in embodiments, record, in the elements of the full-axes candidate permissions matrix and/or active-axes candidate permissions matrix, Boolean values to indicate whether a particular task and resource pair is permitted by the candidate access control assignment. In embodiments, candidate assignment representation generator 204 may record, in the elements of the full-axes candidate permissions matrix and/or active-axes candidate permissions matrix, weighted values based on one or more factors associated with the task and resource pair, such as, but not limited to: the type of permission granted (e.g., create, read, update, delete, etc.), the type of data (e.g., personally identifiable information (PII), medical data, financial information, large datasets, etc.) associated with the resource and/or resource groups, and/or the like.

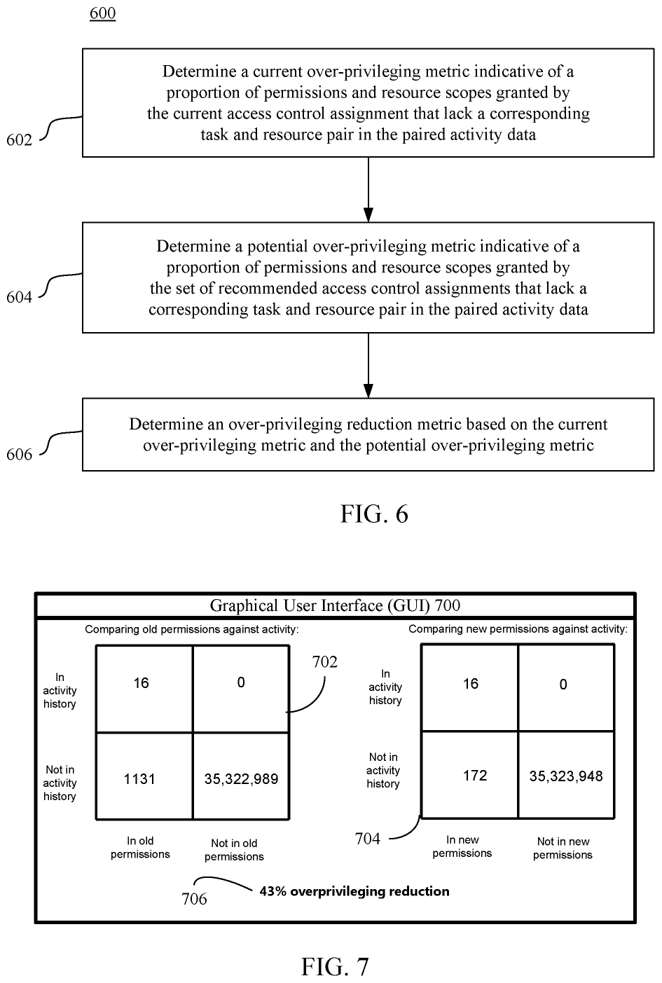

Embodiments described herein may operate in various ways to determine an over-privileging reduction metric. For instance, FIG. 6 depicts a flowchart 600 of a process for determining an over-privileging reduction metric, in accordance with an embodiment. Server(s) 102, permission analyzer 104, candidate assignments database 106, historical database 108, current assignments database 110, cost database 112, and/or cost analyzer 206 of FIGS. 1 and/or 2 may operate according to flowchart 600, for example. Note that not all steps of flowchart 600 may need to be performed in all embodiments, and in some embodiments, the steps of flowchart 600 may be performed in different orders than shown. Flowchart 600 is described as follows with respect to FIGS. 1 and 2 for illustrative purposes.

Flowchart 600 starts at step 602. In step 602, a current over-privileging metric indicative of a proportion of permissions and resource scopes granted by the current access control assignment that lack a corresponding task and resource pair in the paired activity data. For instance, cost analyzer 206 may determine, for current assignments 120 currently assigned to the set of identities 114, an aggregate over-privileging cost based on various factors, such as, but not limited to: the tasks permitted by the current access control assignment, the resources and/or resource groups that the tasks may be performed on, whether the current access control assignment is assigned on a permanent basis or an on-demand basis, the occurrence of task and resource pairs in a historical representation, a frequency of occurrence of task and resource pairs in a historical representation, and/or a pattern of occurrence of task and resource pairs in a historical representation. In embodiments, the over-privileging cost associated with a current access control assignment assigned on a permanent basis may be calculated as the number of permitted task and resource pairs associated with the current access control assignment that do not occur in historical activity of the identity. In embodiments, the over-privileging cost associated with a current access control assignment assigned on an on-demand basis may be calculated as the number of permitted task and resource pairs associated with the current access control assignment and the frequency and/or pattern of occurrence of corresponding task and resource pairs in historical activity of the identity. Furthermore, the over-privileging cost associated with a current access control assignment may, in embodiments, be weighted based on one or more factors, such as, but not limited to: the type of permission granted (e.g., create, read, update, delete, etc.), the type of data (e.g., personally identifiable information (PII), medical data, financial information, large datasets, etc.) associated with the resource and/or resource groups, and/or the like.

In step 604, a potential over-privileging metric indicative of a proportion of permissions and resource scopes granted by the set of recommended access control assignments that lack a corresponding task and resource pair in the paired activity data is determined. For instance, cost analyzer 206 may determine, for recommended assignments 120, an aggregate over-privileging cost based on various factors, such as, but not limited to: the tasks permitted by the recommended access control assignments, the resources and/or resource groups that the tasks may be performed on, whether the recommended access control assignment will be assigned on a permanent basis or an on-demand basis, the occurrence of task and resource pairs in a historical representation, a frequency of occurrence of task and resource pairs in a historical representation, and/or a pattern of occurrence of task and resource pairs in a historical representation. In embodiments, the over-privileging cost associated with a recommended access control assignment that will be assigned on a permanent basis may be calculated as the number of permitted task and resource pairs associated with the current access control assignment that do not occur in historical activity of the identity. In embodiments, the over-privileging cost associated with a recommended access control assignment that will be assigned on an on-demand basis may be calculated as the number of permitted task and resource pairs associated with the current access control assignment and the frequency and/or pattern of occurrence of corresponding task and resource pairs in historical activity of the identity. Furthermore, the over-privileging cost associated with a recommended access control assignment may, in embodiments, be weighted based on one or more factors, such as, but not limited to: the type of permission granted (e.g., create, read, update, delete, etc.), the type of data (e.g., personally identifiable information (PII), medical data, financial information, large datasets, etc.) associated with the resource and/or resource groups, and/or the like.

In step 606, an over-privileging reduction metric is determined based on the current over-privileging metric and the potential over-privileging metric. For instance, cost analyzer 206 may determine an over-privileging reduction metric 226 as a percentage based on

$$\frac{( {\sum }_{current} - {\sum }_{recommended} )}{{\sum }_{current}} ,$$

where Σ_{current} represents an aggregate over-privileging cost associated with current access control assignments currently assigned to an identity, and Σ_{recommended} represents an aggregate over-privileging cost associated with the set of recommended access control assignments. In embodiments, Σ_{current} may be determined by comparing the current permissions matrix to the historical matrix to determine task and resource pairs that are permitted by the current access control assignments with a value of zero in the historical matrix. In embodiments, Σ_{recommended} may be determined by comparing the full-axes candidate permissions matrices associated with the set of recommended access control assignments to the historical matrix to determine task and resource pairs that would be permitted by the set of recommended access control assignments with a value of zero in the historical matrix. In embodiments, the over-privileging reduction metric may be displayed to a customer as a percentage.

Embodiments described herein may operate in various ways to provide a reduced privilege access control assignment recommendation to a customer. For instance, FIG. 7 depicts an example GUI 700 for displaying analytical data associated with replacing a set of current access control assignments with a set of recommended access control assignments, in accordance with an embodiment. Server(s) 102, permission analyzer 104, candidate assignments database 106, historical database 108, current assignments database 110, cost database 112, and/or action handler 212 of FIGS. 1 and/or 2 may operate according to GUI 700, for example. GUI 700 is described as follows with respect to FIGS. 1 and 2 for illustrative purposes.

FIG. 7 depicts a GUI 700 including graphical analytical data in the form of two tables. Table 702 is a graphical representation of the number of permitted task and resource pairs granted by current access control assignments of an identity and the number of task and resource pairs that occur in the historical representation of the identity. Table 704 is a graphical representation of the number of permitted task and resource pairs granted by the recommended access control assignments and the number of task and resource pairs that occur in the historical representation of the identity. Over-privileging reduction metric 706 is a percent reduction of over-privileging associated with replacing the current access control assignments currently assigned to the identity with the recommended access control assignments.

### III. Example Mobile Device and Computer System Implementation

The systems and methods described above in reference to FIGS. 1-7, server(s) 102, permission analyzer 104, candidate assignments database 106, historical database 108, current assignments database 110, cost database 112, historical representation generator 202, candidate assignment representation generator 204, cost analyzer 206, candidate assignment selector 208, current assignment representation generator 210, action handler 212, rollback database 214, and/or each of the components described therein, and/or the steps of flowcharts 300, 400, 500, and/or 600, and/or GUI 700 may be implemented in hardware, or hardware combined with one or both of software and/or firmware. For example, server(s) 102, permission analyzer 104, candidate assignments database 106, historical database 108, current assignments database 110, cost database 112, historical representation generator 202, candidate assignment representation generator 204, cost analyzer 206, candidate assignment selector 208, current assignment representation generator 210, action handler 212, rollback database 214, and/or each of the components described therein, and/or the steps of flowcharts 300, 400, 500, and/or 600, and/or GUI 700 may be each implemented as computer program code/instructions configured to be executed in one or more processors and stored in a computer readable storage medium, and structured to performed the respective flowchart functions/operations. Alternatively, server(s) 102, permission analyzer 104, candidate assignments database 106, historical database 108, current assignments database 110, cost database 112, historical representation generator 202, candidate assignment representation generator 204, cost analyzer 206, candidate assignment selector 208, current assignment representation generator 210, action handler 212, rollback database 214, and/or each of the components described therein, and/or the steps of flowcharts 300, 400, 500, and/or 600, and/or GUI 700 may be implemented in one or more SoCs (system on chip). An SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 8. FIG. 8 shows a block diagram of an exemplary computing environment 800 that includes a computing device 802. In some embodiments, computing device 802 is communicatively coupled with devices (not shown in FIG. 8) external to computing environment 800 via network 804. Network 804 comprises one or more networks such as local area networks (LANs), wide area networks (WANs), enterprise networks, the Internet, etc., and may include one or more wired and/or wireless portions. Network 804 may additionally or alternatively include a cellular network for cellular communications. Computing device 802 is described in detail as follows

Computing device 802 can be any of a variety of types of computing devices. For example, computing device 802 may be a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. Computing device 802 may alternatively be a stationary computing device such as a desktop computer, a personal computer (PC), a stationary server device, a minicomputer, a mainframe, a supercomputer, etc.

As shown in FIG. 8, computing device 802 includes a variety of hardware and software components, including a processor 810, a storage 820, one or more input devices 830, one or more output devices 850, one or more wireless modems 860, one or more wired interfaces 880, a power supply 882, a location information (LI) receiver 884, and an accelerometer 886. Storage 820 includes memory 856, which includes non-removable memory 822 and removable memory 824, and a storage device 890. Storage 820 also stores an operating system 812, application programs 814, and application data 816. Wireless modem(s) 860 include a Wi-Fi modem 862, a Bluetooth modem 864, and a cellular modem 866. Output device(s) 850 includes a speaker 852 and a display 854. Input device(s) 830 includes a touch screen 832, a microphone 834, a camera 836, a physical keyboard 838, and a trackball 840. Not all components of computing device 802 shown in FIG. 8 are present in all embodiments, additional components not shown may be present, and any combination of the components may be present in a particular embodiment. These components of computing device 802 are described as follows.

A single processor 810 (e.g., central processing unit (CPU), microcontroller, a microprocessor, signal processor, ASIC (application specific integrated circuit), and/or other physical hardware processor circuit) or multiple processors 810 may be present in computing device 802 for performing such tasks as program execution, signal coding, data processing, input/output processing, power control, and/or other functions. Processor 810 may be a single-core or multi-core processor, and each processor core may be single-threaded or multithreaded (to provide multiple threads of execution concurrently). Processor 810 is configured to execute program code stored in a computer readable medium, such as program code of operating system 812 and application programs 814 stored in storage 820. The program code is structured to cause processor 810 to perform operations, including the processes/methods disclosed herein. Operating system 812 controls the allocation and usage of the components of computing device 802 and provides support for one or more application programs 814 (also referred to as “applications” or “apps”). Application programs 814 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. Processor(s) 810 may include one or more general processors (e.g., CPUs) configured with or coupled to one or more hardware accelerators, such as one or more NPUs and/or one or more GPUs.

Any component in computing device 802 can communicate with any other component according to function, although not all connections are shown for ease of illustration. For instance, as shown in FIG. 8, bus 806 is a multiple signal line communication medium (e.g., conductive traces in silicon, metal traces along a motherboard, wires, etc.) that may be present to communicatively couple processor 810 to various other components of computing device 802, although in other embodiments, an alternative bus, further buses, and/or one or more individual signal lines may be present to communicatively couple components. Bus 806 represents one or more of any of several types of bus structures, including a memory bus or memory controller, a peripheral bus, an accelerated graphics port, and a processor or local bus using any of a variety of bus architectures.

Storage 820 is physical storage that includes one or both of memory 856 and storage device 890, which store operating system 812, application programs 814, and application data 816 according to any distribution. Non-removable memory 822 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 822 may include main memory and may be separate from or fabricated in a same integrated circuit as processor 810. As shown in FIG. 8, non-removable memory 822 stores firmware 818, which may be present to provide low-level control of hardware. Examples of firmware 818 include BIOS (Basic Input/Output System, such as on personal computers) and boot firmware (e.g., on smart phones). Removable memory 824 may be inserted into a receptacle of or otherwise coupled to computing device 802 and can be removed by a user from computing device 802. Removable memory 824 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 890 may be present that are internal and/or external to a housing of computing device 802 and may or may not be removable. Examples of storage device 890 include a hard disk drive, a SSD, a thumb drive (e.g., a USB (Universal Serial Bus) flash drive), or other physical storage device.

One or more programs may be stored in storage 820. Such programs include operating system 812, one or more application programs 814, and other program modules and program data. Examples of such application programs may include, for example, computer program logic (e.g., computer program code/instructions) for implementing one or more of server(s) 102, permission analyzer 104, candidate assignments database 106, historical database 108, current assignments database 110, cost database 112, historical representation generator 202, candidate assignment representation generator 204, cost analyzer 206, candidate assignment selector 208, current assignment representation generator 210, action handler 212, rollback database 214, and/or subcomponents thereof, as well as the flowcharts/flow diagrams (e.g., flowcharts 300, 400, 500, and/or 600) described herein, including portions thereof, and/or GUI 700 described herein, including portions thereof, and/or further examples described herein.

Storage 820 also stores data used and/or generated by operating system 812 and application programs 814 as application data 816. Examples of application data 816 include web pages, text, images, tables, sound files, video data, and other data, which may also be sent to and/or received from one or more network servers or other devices via one or more wired or wireless networks. Storage 820 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 802 through one or more input devices 830 and may receive information from computing device 802 through one or more output devices 850. Input device(s) 830 may include one or more of touch screen 832, microphone 834, camera 836, physical keyboard 838 and/or trackball 840 and output device(s) 850 may include one or more of speaker 852 and display 854. Each of input device(s) 830 and output device(s) 850 may be integral to computing device 802 (e.g., built into a housing of computing device 802) or external to computing device 802 (e.g., communicatively coupled wired or wirelessly to computing device 802 via wired interface(s) 880 and/or wireless modem(s) 860). Further input devices 830 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 854 may display information, as well as operating as touch screen 832 by receiving user commands and/or other information (e.g., by touch, finger gestures, virtual keyboard, etc.) as a user interface. Any number of each type of input device(s) 830 and output device(s) 850 may be present, including multiple microphones 834, multiple cameras 836, multiple speakers 852, and/or multiple displays 854.

One or more wireless modems 860 can be coupled to antenna(s) (not shown) of computing device 802 and can support two-way communications between processor 810 and devices external to computing device 802 through network 804, as would be understood to persons skilled in the relevant art(s). Wireless modem 860 is shown generically and can include a cellular modem 866 for communicating with one or more cellular networks, such as a GSM network for data and voice communications within a single cellular network, between cellular networks, or between the mobile device and a public switched telephone network (PSTN). Wireless modem 860 may also or alternatively include other radio-based modem types, such as a Bluetooth modem 864 (also referred to as a “Bluetooth device”) and/or Wi-Fi modem 862 (also referred to as an “wireless adaptor”). Wi-Fi modem 862 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 864 is configured to communicate with another Bluetooth-capable device according to the Bluetooth short-range wireless technology standard(s) such as IEEE 802.15.1 and/or managed by the Bluetooth Special Interest Group (SIG).

Computing device 802 can further include power supply 882, LI receiver 884, accelerometer 886, and/or one or more wired interfaces 880. Example wired interfaces 880 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 880 of computing device 802 provide for wired connections between computing device 802 and network 804, or between computing device 802 and one or more devices/peripherals when such devices/peripherals are external to computing device 802 (e.g., a pointing device, display 854, speaker 852, camera 836, physical keyboard 838, etc.). Power supply 882 is configured to supply power to each of the components of computing device 802 and may receive power from a battery internal to computing device 802, and/or from a power cord plugged into a power port of computing device 802 (e.g., a USB port, an A/C power port). LI receiver 884 may be used for location determination of computing device 802 and may include a satellite navigation receiver such as a Global Positioning System (GPS) receiver or may include other type of location determiner configured to determine location of computing device 802 based on received information (e.g., using cell tower triangulation, etc.). Accelerometer 886 may be present to determine an orientation of computing device 802.

Note that the illustrated components of computing device 802 are not required or all-inclusive, and fewer or greater numbers of components may be present as would be recognized by one skilled in the art. For example, computing device 802 may also include one or more of a gyroscope, barometer, proximity sensor, ambient light sensor, digital compass, etc. Processor 810 and memory 856 may be co-located in a same semiconductor device package, such as being included together in an integrated circuit chip, FPGA, or system-on-chip (SOC), optionally along with further components of computing device 802.

In embodiments, computing device 802 is configured to implement any of the above-described features of flowcharts herein. Computer program logic for performing any of the operations, steps, and/or functions described herein may be stored in storage 820 and executed by processor 810.

In some embodiments, server infrastructure 870 may be present in computing environment 800 and may be communicatively coupled with computing device 802 via network 804. Server infrastructure 870, when present, may be a network-accessible server set (e.g., a cloud-based environment or platform). As shown in FIG. 8, server infrastructure 870 includes clusters 872. Each of clusters 872 may comprise a group of one or more compute nodes and/or a group of one or more storage nodes. For example, as shown in FIG. 8, cluster 872 includes nodes 874. Each of nodes 874 are accessible via network 804 (e.g., in a “cloud-based” embodiment) to build, deploy, and manage applications and services. Any of nodes 874 may be a storage node that comprises a plurality of physical storage disks, SSDs, and/or other physical storage devices that are accessible via network 804 and are configured to store data associated with the applications and services managed by nodes 874. For example, as shown in FIG. 8, nodes 874 may store application data 878.

Each of nodes 874 may, as a compute node, comprise one or more server computers, server systems, and/or computing devices. For instance, a node 874 may include one or more of the components of computing device 802 disclosed herein. Each of nodes 874 may be configured to execute one or more software applications (or “applications”) and/or services and/or manage hardware resources (e.g., processors, memory, etc.), which may be utilized by users (e.g., customers) of the network-accessible server set. For example, as shown in FIG. 8, nodes 874 may operate application programs 876. In an implementation, a node of nodes 874 may operate or comprise one or more virtual machines, with each virtual machine emulating a system architecture (e.g., an operating system), in an isolated manner, upon which applications such as application programs 876 may be executed.

In an embodiment, one or more of clusters 872 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 872 may be a datacenter in a distributed collection of datacenters. In embodiments, exemplary computing environment 800 comprises part of a cloud-based platform.

In an embodiment, computing device 802 may access application programs 876 for execution in any manner, such as by a client application and/or a browser at computing device 802.

For purposes of network (e.g., cloud) backup and data security, computing device 802 may additionally and/or alternatively synchronize copies of application programs 814 and/or application data 816 to be stored at network-based server infrastructure 870 as application programs 876 and/or application data 878. For instance, operating system 812 and/or application programs 814 may include a file hosting service client configured to synchronize applications and/or data stored in storage 820 at network-based server infrastructure 870.

In some embodiments, on-premises servers 892 may be present in computing environment 800 and may be communicatively coupled with computing device 802 via network 804. On-premises servers 892, when present, are hosted within an organization's infrastructure and, in many cases, physically onsite of a facility of that organization. On-premises servers 892 are controlled, administered, and maintained by IT (Information Technology) personnel of the organization or an IT partner to the organization. Application data 898 may be shared by on-premises servers 892 between computing devices of the organization, including computing device 802 (when part of an organization) through a local network of the organization, and/or through further networks accessible to the organization (including the Internet). Furthermore, on-premises servers 892 may serve applications such as application programs 896 to the computing devices of the organization, including computing device 802. Accordingly, on-premises servers 892 may include storage 894 (which includes one or more physical storage devices such as storage disks and/or SSDs) for storage of application programs 896 and application data 898 and may include one or more processors for execution of application programs 896. Still further, computing device 802 may be configured to synchronize copies of application programs 814 and/or application data 816 for backup storage at on-premises servers 892 as application programs 896 and/or application data 898.

Embodiments described herein may be implemented in one or more of computing device 802, network-based server infrastructure 870, and on-premises servers 892. For example, in some embodiments, computing device 802 may be used to implement systems, clients, or devices, or components/subcomponents thereof, disclosed elsewhere herein. In other embodiments, a combination of computing device 802, network-based server infrastructure 870, and/or on-premises servers 892 may be used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 820. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 814) may be stored in storage 820. Such computer programs may also be received via wired interface(s) 880 and/or wireless modem(s) 860 over network 804. Such computer programs, when executed or loaded by an application, enable computing device 802 to implement features of embodiments discussed herein. Accordingly, such computer programs represent controllers of the computing device 802.

Embodiments are also directed to computer program products comprising computer code or instructions stored on any computer-readable medium or computer-readable storage medium. Such computer program products include the physical storage of storage 820 as well as further physical storage types.

### IV. Additional Example Embodiments

In an embodiment, a method comprises: determining, from historical activity data, paired activity data associated with an identity, the paired activity data comprising task and resource pairs, a task and resource pair indicating a task performed by the identity and a resource on which the task was performed; determining, for a particular candidate access control assignment of a plurality of candidate access control assignments, an over-privileging cost based on the permitted tasks and resource scopes granted by the particular candidate access control assignment and the paired activity data; determining, for the identity, a set of recommended access control assignments as a subset of the plurality of candidate access control assignments with a lowest aggregate over-privileging cost whose combined permissions and resource scopes cover at least a predetermined percentage of the paired activity data; generating, based on the set of recommended access control assignments, a recommended assignment state for the particular candidate access control assignment; and performing an action based on the recommended assignment state.

In an embodiment, the recommended assignment state comprises at least one of: excepting the particular candidate access control assignment from being assigned to the identity, assigning the particular candidate access control assignment to the identity on a permanent basis, or assigning the particular candidate access control assignment to the identity on an on-demand basis.

In an embodiment, determining, for the particular candidate access control assignment, an over-privileging cost comprises: determining, for the particular access control assignment, a first over-privileging cost based on permissions and a resource scopes granted by the particular candidate access control assignment on a permanent basis, and the paired activity data; and determining, for the particular access control assignment, a second over-privileging cost based on the permitted tasks and the resource scopes granted by the particular candidate access control assignment on an on-demand basis, and a frequency or pattern of task and resource pairs in the paired activity data; wherein determining the set of recommended access control assignments comprises: determining, based on the first over-privileging cost and the second over-privileging cost, that a recommended access control assignment of the set of recommended access control assignments should be assigned on at least one of a permanent basis or an on-demand basis.

In an embodiment, determining, for the particular access control assignment, a first over-privileging cost comprises at least one of: determining the first over-privileging cost based on a permission type of the permitted tasks granted by the particular candidate access control assignment; determining the first over-privileging cost based on a data type of the resource scopes granted by the particular candidate access control assignment; determining the first over-privileging cost based on a data size of the resource scopes granted by the particular candidate access control assignment; or determining the first over-privileging cost based on a presence of task and resource pairs in the paired activity data that correspond to permissions and resource scopes granted by the particular candidate access control assignment.

In an embodiment, determining, for the particular access control assignment, a second over-privileging cost comprises at least one of: determining the second over-privileging cost based on a frequency of occurrence of task and resource pairs in the paired activity data that correspond to permissions and resource scopes granted by the particular candidate access control assignment; or determining the second over-privileging cost based on a pattern of task and resource pairs in the paired activity data that correspond to permissions and resource scopes granted by the particular candidate access control assignment.

In an embodiment, performing the action comprises at least one of: providing, to a user, a recommendation to keep a current access control assignment currently assigned to the identity; providing, to a user, a recommendation to reassign, on an on-demand basis a current access control assignment currently assigned to the identity on a permanent basis; providing, to a user, a recommendation to reassign, on a permanent basis, a current access control assignment currently assigned to the identity on an on-demand basis; providing, to a user, a recommendation to replace a current access control assignment currently assigned to the identity with at least a portion of the set of recommended access control assignments on a permanent basis; providing, to a user, a recommendation to assign a recommended access control assignment in the set of recommended access control assignments on a permanent basis; providing, to a user, a recommendation to assign a recommended access control assignment in the set of recommended access control assignments to the identity on an on-demand basis; automatically reassigning, on an on-demand basis, a current access control assignment currently assigned to the identity on a permanent basis; automatically reassigning, on a permanent basis, a current access control assignment currently assigned to the identity on an on-demand basis; automatically replacing a current access control assignment currently assigned to the identity with at least a portion of the set of recommended access control assignments; automatically assigning a recommended access control assignment in the set of recommended access control assignments to the identity on a permanent basis; or automatically assigning a recommended access control assignment in the set of recommended access control assignments to the identity on an on-demand basis.

In an embodiment, the plurality of candidate access control assignments comprise at least one of: a built-in role associated with a first cloud platform provider and a first resource scope, the built-in role associated with a first set of role permissions to perform a first set of tasks on resources associated with the first resource scope; a built-in policy associated with a second cloud platform provider, the built-in policy associated with a first set of policy permissions to perform a second set of tasks, and a first set of policy resources on which the second set of tasks may be performed; a customer-defined role and a second resource scope, the customer-defined role associated with a second set of role permissions to perform a third set of tasks on resources associated with the second resource scope; or a customer-defined policy associated, the customer-defined policy associated with a second set of policy permissions to perform a fourth set of tasks, and a second set of policy resources on which the fourth set of tasks may be performed.

In an embodiment, the method further includes: determining a current over-privileging metric indicative of a proportion of permissions and resource scopes granted by the current access control assignment that lack a corresponding task and resource pair in the paired activity data; determining a potential over-privileging metric indicative of a proportion of permissions and resource scopes granted by the set of recommended access control assignments that lack a corresponding task and resource pair in the paired activity data; and determining an over-privileging reduction metric based on the current over-privileging metric and the potential over-privileging metric, wherein said performing the action is further based on the over-privileging reduction metric.

In an embodiment, a system comprises: a processor; and a memory device comprising program code structured to cause the processor to: determine, from historical activity data, paired activity data associated with an identity, the paired activity data comprising task and resource pairs, a task and resource pair indicating a task performed by the identity and a resource on which the task was performed; determine, for a particular candidate access control assignment of a plurality of candidate access control assignments, an over-privileging cost based on a permitted task and resource scope granted by the particular candidate access control assignment and the paired activity data; determine, for the identity, a set of recommended access control assignments as a subset of the plurality of candidate access control assignments with a lowest aggregate over-privileging cost whose combined permissions and resource scopes cover at least a predetermined percentage of the paired activity data; generate, based on the set of recommended access control assignments, a recommended assignment state for the particular candidate access control assignment; and perform an action based on the recommended assignment state.

In an embodiment, the recommended assignment state comprises at least one of: excepting the particular candidate access control assignment from being assigned to the identity, assigning the particular candidate access control assignment to the identity on a permanent basis, or assigning the particular candidate access control assignment to the identity on an on-demand basis.

In an embodiment, to determine, for the particular candidate access control assignment, the over-privileging cost, the program code is further structured to cause the processor to: determine, for the particular access control assignment, a first over-privileging cost based on permissions and a resource scopes granted by the particular candidate access control assignment on a permanent basis, and the paired activity data; and determine, for the particular access control assignment, a second over-privileging cost based on the permitted tasks and the resource scopes granted by the particular candidate access control assignment on an on-demand basis, and a frequency or pattern of task and resource pairs in the paired activity data; wherein, to determine the set of recommended access control assignments, the program code is further structured to cause the processor to: determine, based on the first over-privileging cost and the second over-privileging cost, that a recommended access control assignment of the set of recommended access control assignments should be assigned on at least one of a permanent basis or an on-demand basis.

In an embodiment, to determine, for the particular access control assignment, the first over-privileging cost, the program code is further structured to cause the processor to perform at least one of: determine the first over-privileging cost based on a permission type of the permitted tasks granted by the particular candidate access control assignment; determine the first over-privileging cost based on a data type of the resource scopes granted by the particular candidate access control assignment; determine the first over-privileging cost based on a data size of the resource scopes granted by the particular candidate access control assignment; or determine the first over-privileging cost based on a presence of task and resource pairs in the paired activity data that correspond to permissions and resource scopes granted by the particular candidate access control assignment.

In an embodiment, to determine, for the particular access control assignment, the second over-privileging cost, the program code is further structured to cause the processor to perform at least one of: determine the second over-privileging cost based on a frequency of occurrence of task and resource pairs in the paired activity data that correspond to permissions and resource scopes granted by the particular candidate access control assignment; or determine the second over-privileging cost based on a pattern of task and resource pairs in the paired activity data that correspond to permissions and resource scopes granted by the particular candidate access control assignment.

In an embodiment, to perform the action, the program code is further structured to cause the processor to perform at least one of: provide, to a user, a recommendation to keep a current access control assignment currently assigned to the identity; provide, to a user, a recommendation to reassign, on an on-demand basis, a current access control assignment currently assigned to the identity on a permanent basis; provide, to a user, a recommendation to reassign, on a permanent basis, a current access control assignment currently assigned to the identity on an on-demand basis; provide, to a user, a recommendation to replace a current access control assignment currently assigned to the identity with at least a portion of the set of recommended access control assignments on a permanent basis; provide, to a user, a recommendation to assign a recommended access control assignment in the set of recommended access control assignments on a permanent basis; provide, to a user, a recommendation to assign a recommended access control assignment in the set of recommended access control assignments to the identity on an on-demand basis; automatically reassign, on an on-demand basis, a current access control assignment currently assigned to the identity on a permanent basis; automatically reassign, on a permanent basis, a current access control assignment currently assigned to the identity on an on-demand basis; automatically replace a current access control assignment currently assigned to the identity with at least a portion of the set of recommended access control assignments; automatically assign a recommended access control assignment in the set of recommended access control assignments to the identity on a permanent basis; or automatically assign a recommended access control assignment in the set of recommended access control assignments to the identity on an on-demand basis.

In an embodiment, a computer-readable storage medium comprises computer-executable instructions that, when executed by a processor, cause the processor to: determine, from historical activity data, paired activity data associated with an identity, the paired activity data comprising task and resource pairs, a task and resource pair indicating a task performed by the identity and a resource on which the task was performed; determine, for a particular candidate access control assignment of a plurality of candidate access control assignments, an over-privileging cost based on a permitted task and resource scope granted by the particular candidate access control assignment and the paired activity data; determine, for the identity, a set of recommended access control assignments as a subset of the plurality of candidate access control assignments with a lowest aggregate over-privileging cost whose combined permissions and resource scopes cover at least a predetermined percentage of the paired activity data; generate, based on the set of recommended access control assignments, a recommended assignment state for the particular candidate access control assignment; and perform an action based on the recommended assignment state.

In an embodiment, the recommended assignment state comprises at least one of: excepting the particular candidate access control assignment from being assigned to the identity, assigning the particular candidate access control assignment to the identity on a permanent basis, or assigning the particular candidate access control assignment to the identity on an on-demand basis.

In an embodiment, to determine, for the particular candidate access control assignment, the over-privileging cost, the computer-executable instructions, when executed by the processor, further cause the processor to: determine, for the particular access control assignment, a first over-privileging cost based on permissions and a resource scopes granted by the particular candidate access control assignment on a permanent basis, and the paired activity data; and determine, for the particular access control assignment, a second over-privileging cost based on the permitted tasks and the resource scopes granted by the particular candidate access control assignment on an on-demand basis, and a frequency or pattern of task and resource pairs in the paired activity data; wherein, to determine the set of recommended access control assignments, the computer-executable instructions, when executed by the processor, further cause the processor to: determine, based on the first over-privileging cost and the second over-privileging cost, that a recommended access control assignment of the set of recommended access control assignments should be assigned on at least one of a permanent basis or an on-demand basis.

In an embodiment, to determine, for the particular access control assignment, the first over-privileging cost, the computer-executable instructions, when executed by the processor, further cause the processor to perform at least one of: determine the first over-privileging cost based on a permission type of the permitted tasks granted by the particular candidate access control assignment; determine the first over-privileging cost based on a data type of the resource scopes granted by the particular candidate access control assignment; determine the first over-privileging cost based on a data size of the resource scopes granted by the particular candidate access control assignment; or determine the first over-privileging cost based on a presence of task and resource pairs in the paired activity data that correspond to permissions and resource scopes granted by the particular candidate access control assignment.

In an embodiment, to determine, for the particular access control assignment, the second over-privileging cost, the computer-executable instructions, when executed by the processor, further cause the processor to perform at least one of: determine the second over-privileging cost based on a frequency of occurrence of task and resource pairs in the paired activity data that correspond to permissions and resource scopes granted by the particular candidate access control assignment; or determine the second over-privileging cost based on a pattern of task and resource pairs in the paired activity data that correspond to permissions and resource scopes granted by the particular candidate access control assignment.

In an embodiment, to perform the action, the computer-executable instructions, when executed by the processor, further cause the processor to perform at least one of: provide, to a user, a recommendation to keep a current access control assignment currently assigned to the identity; provide, to a user, a recommendation to reassign, on an on-demand basis, a current access control assignment currently assigned to the identity on a permanent basis; provide, to a user, a recommendation to reassign, on a permanent basis, a current access control assignment currently assigned to the identity on an on-demand basis; provide, to a user, a recommendation to replace a current access control assignment currently assigned to the identity with at least a portion of the set of recommended access control assignments on a permanent basis; provide, to a user, a recommendation to assign a recommended access control assignment in the set of recommended access control assignments on a permanent basis; provide, to a user, a recommendation to assign a recommended access control assignment in the set of recommended access control assignments to the identity on an on-demand basis; automatically reassign, on an on-demand basis, a current access control assignment currently assigned to the identity on a permanent basis; automatically reassign, on a permanent basis, a current access control assignment currently assigned to the identity on an on-demand basis; automatically replace a current access control assignment currently assigned to the identity with at least a portion of the set of recommended access control assignments; automatically assign a recommended access control assignment in the set of recommended access control assignments to the identity on a permanent basis; or automatically assign a recommended access control assignment in the set of recommended access control assignments to the identity on an on-demand basis.

### V. CONCLUSION

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Furthermore, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

While various embodiments of the present disclosure have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method comprising:
determining, from historical activity data, paired activity data associated with an identity, the paired activity data comprising task and resource pairs, a task and resource pair indicating a task performed by the identity and a resource on which the task was performed;
determining, for a particular candidate access control assignment of a plurality of candidate access control assignments, an over-privileging cost based on a permission and resource scope granted by the particular candidate access control assignment and the paired activity data;
determining, for the identity, a set of recommended access control assignments as a subset of the plurality of candidate access control assignments with a lowest aggregate over-privileging cost whose combined permissions and resource scopes cover at least a predetermined percentage of the paired activity data;
generating, based on the set of recommended access control assignments, a recommended assignment state for the particular candidate access control assignment; and
performing a responsive action based on the recommended assignment state.

2. The method of claim 1, wherein the recommended assignment state comprises at least one of:
excepting the particular candidate access control assignment from being assigned to the identity,
assigning the particular candidate access control assignment to the identity on a permanent basis, or
assigning the particular candidate access control assignment to the identity on an on-demand basis.

3. The method of claim 1, wherein said determining, for the particular candidate access control assignment, the over-privileging cost comprises:
determining, for the particular access control assignment, a first over-privileging cost based on permissions and a resource scopes granted by the particular candidate access control assignment on a permanent basis, and the paired activity data; and
determining, for the particular access control assignment, a second over-privileging cost based on the permitted tasks and the resource scopes granted by the particular candidate access control assignment on an on-demand basis, and a frequency or pattern of task and resource pairs in the paired activity data;
wherein determining the set of recommended access control assignments comprises: determining, based on the first over-privileging cost and the second over-privileging cost, that a recommended access control assignment of the set of recommended access control assignments should be assigned on at least one of a permanent basis or an on-demand basis.

4. The method of claim 3, wherein said determining, for the particular access control assignment, the first over-privileging cost comprises at least one of:
determining the first over-privileging cost based on a permission type of the permitted tasks granted by the particular candidate access control assignment;
determining the first over-privileging cost based on a data type of the resource scopes granted by the particular candidate access control assignment;
determining the first over-privileging cost based on a data size of the resource scopes granted by the particular candidate access control assignment; or
determining the first over-privileging cost based on a presence of task and resource pairs in the paired activity data that correspond to permissions and resource scopes granted by the particular candidate access control assignment.

5. The method of claim 3, wherein said determining, for the particular access control assignment, the second over-privileging cost comprises at least one of:
determining the second over-privileging cost based on a frequency of occurrence of task and resource pairs in the paired activity data that correspond to permissions and resource scopes granted by the particular candidate access control assignment; or
determining the second over-privileging cost based on a pattern of task and resource pairs in the paired activity data that correspond to permissions and resource scopes granted by the particular candidate access control assignment.

6. The method of claim 1, wherein said performing the action comprises at least one of:
providing, to a user, a recommendation to keep a current access control assignment currently assigned to the identity;
providing, to a user, a recommendation to reassign, on an on-demand basis, a current access control assignment currently assigned to the identity on a permanent basis;
providing, to a user, a recommendation to reassign, on a permanent basis, a current access control assignment currently assigned to the identity on an on-demand basis;
providing, to a user, a recommendation to replace a current access control assignment currently assigned to the identity with at least a portion of the set of recommended access control assignments on a permanent basis;
providing, to a user, a recommendation to assign a recommended access control assignment in the set of recommended access control assignments on a permanent basis;
providing, to a user, a recommendation to assign a recommended access control assignment in the set of recommended access control assignments to the identity on an on-demand basis;
automatically reassigning, on an on-demand basis, a current access control assignment currently assigned to the identity on a permanent basis;
automatically reassigning, on a permanent basis, a current access control assignment currently assigned to the identity on an on-demand basis;
automatically replacing a current access control assignment currently assigned to the identity with at least a portion of the set of recommended access control assignments;
automatically assigning a recommended access control assignment in the set of recommended access control assignments to the identity on a permanent basis; or
automatically assigning a recommended access control assignment in the set of recommended access control assignments to the identity on an on-demand basis.

7. The method of claim 1, wherein the plurality of candidate access control assignments comprise at least one of:
a built-in role associated with a first cloud platform provider and a first resource scope, the built-in role associated with a first set of role permissions to perform a first set of tasks on resources associated with the first resource scope;
a built-in policy associated with a second cloud platform provider, the built-in policy associated with a first set of policy permissions to perform a second set of tasks, and a first set of policy resources on which the second set of tasks may be performed;
a customer-defined role and a second resource scope, the customer-defined role associated with a second set of role permissions to perform a third set of tasks on resources associated with the second resource scope; or
a customer-defined policy associated, the customer-defined policy associated with a second set of policy permissions to perform a fourth set of tasks, and a second set of policy resources on which the fourth set of tasks may be performed.

8. The method of claim 1, further comprising:
determining a current over-privileging metric indicative of a proportion of permissions and resource scopes granted by the current access control assignment that lack a corresponding task and resource pair in the paired activity data;
determining a potential over-privileging metric indicative of a proportion of permissions and resource scopes granted by the set of recommended access control assignments that lack a corresponding task and resource pair in the paired activity data; and
determining an over-privileging reduction metric based on the current over-privileging metric and the potential over-privileging metric,
wherein said performing the action is further based on the over-privileging reduction metric.

9. A system comprising:
a processor; and
a memory device comprising program code structured to cause the processor to:
determine, from historical activity data, paired activity data associated with an identity, the paired activity data comprising task and resource pairs, a task and resource pair indicating a task performed by the identity and a resource on which the task was performed;
determine, for a particular candidate access control assignment of a plurality of candidate access control assignments, an over-privileging cost based on a permitted task and resource scope granted by the particular candidate access control assignment and the paired activity data;
determine, for the identity, a set of recommended access control assignments as a subset of the plurality of candidate access control assignments with a lowest aggregate over-privileging cost whose combined permissions and resource scopes cover at least a predetermined percentage of the paired activity data;
generate, based on the set of recommended access control assignments, a recommended assignment state for the particular candidate access control assignment; and
perform a responsive action based on the recommended assignment state.

10. The system of claim 9, wherein the recommended assignment state comprises at least one of:
excepting the particular candidate access control assignment from being assigned to the identity,
assigning the particular candidate access control assignment to the identity on a permanent basis, or
assigning the particular candidate access control assignment to the identity on an on-demand basis.

11. The system of claim 9, wherein, to determine, for the particular candidate access control assignment, the over-privileging cost, the program code is further structured to cause the processor to:
determine, for the particular access control assignment, a first over-privileging cost based on permissions and a resource scopes granted by the particular candidate access control assignment on a permanent basis, and the paired activity data; and
determine, for the particular access control assignment, a second over-privileging cost based on the permitted tasks and the resource scopes granted by the particular candidate access control assignment on an on-demand basis, and a frequency or pattern of task and resource pairs in the paired activity data;
wherein, to determine the set of recommended access control assignments, the program code is further structured to cause the processor to: determine, based on the first over-privileging cost and the second over-privileging cost, that a recommended access control assignment of the set of recommended access control assignments should be assigned on at least one of a permanent basis or an on-demand basis.

12. The system of claim 11, wherein, to determine, for the particular access control assignment, the first over-privileging cost, the program code is further structured to cause the processor to perform at least one of:
determine the first over-privileging cost based on a permission type of the permitted tasks granted by the particular candidate access control assignment;
determine the first over-privileging cost based on a data type of the resource scopes granted by the particular candidate access control assignment;
determine the first over-privileging cost based on a data size of the resource scopes granted by the particular candidate access control assignment; or
determine the first over-privileging cost based on a presence of task and resource pairs in the paired activity data that correspond to permissions and resource scopes granted by the particular candidate access control assignment.

13. The system of claim 11, wherein, to determine, for the particular access control assignment, the second over-privileging cost, the program code is further structured to cause the processor to perform at least one of:
determine the second over-privileging cost based on a frequency of occurrence of task and resource pairs in the paired activity data that correspond to permissions and resource scopes granted by the particular candidate access control assignment; or
determine the second over-privileging cost based on a pattern of task and resource pairs in the paired activity data that correspond to permissions and resource scopes granted by the particular candidate access control assignment.

14. The system of claim 9, wherein, to perform the action, the program code is further structured to cause the processor to perform at least one of:
provide, to a user, a recommendation to keep a current access control assignment currently assigned to the identity;
provide, to a user, a recommendation to reassign, on an on-demand basis, a current access control assignment currently assigned to the identity on a permanent basis;
provide, to a user, a recommendation to reassign, on a permanent basis, a current access control assignment currently assigned to the identity on an on-demand basis;
provide, to a user, a recommendation to replace a current access control assignment currently assigned to the identity with at least a portion of the set of recommended access control assignments on a permanent basis;
provide, to a user, a recommendation to assign a recommended access control assignment in the set of recommended access control assignments on a permanent basis;
provide, to a user, a recommendation to assign a recommended access control assignment in the set of recommended access control assignments to the identity on an on-demand basis;
automatically reassign, on an on-demand basis, a current access control assignment currently assigned to the identity on a permanent basis;
automatically reassign, on a permanent basis, a current access control assignment currently assigned to the identity on an on-demand basis;
automatically replace a current access control assignment currently assigned to the identity with at least a portion of the set of recommended access control assignments;
automatically assign a recommended access control assignment in the set of recommended access control assignments to the identity on a permanent basis; or
automatically assign a recommended access control assignment in the set of recommended access control assignments to the identity on an on-demand basis.

15. A computer-readable storage medium comprising computer-executable instructions that, when executed by a processor, cause the processor to:
determine, from historical activity data, paired activity data associated with an identity, the paired activity data comprising task and resource pairs, a task and resource pair indicating a task performed by the identity and a resource on which the task was performed;
determine, for a particular candidate access control assignment of a plurality of candidate access control assignments, an over-privileging cost based on a permitted task and resource scope granted by the particular candidate access control assignment and the paired activity data;
determine, for the identity, a set of recommended access control assignments as a subset of the plurality of candidate access control assignments with a lowest aggregate over-privileging cost whose combined permissions and resource scopes cover at least a predetermined percentage of the paired activity data;
generate, based on the set of recommended access control assignments, a recommended assignment state for the particular candidate access control assignment; and
perform a responsive action based on the recommended assignment state.

16. The computer-readable storage medium of claim 15, wherein the recommended assignment state comprises at least one of:
excepting the particular candidate access control assignment from being assigned to the identity,
assigning the particular candidate access control assignment to the identity on a permanent basis, or
assigning the particular candidate access control assignment to the identity on an on-demand basis.

17. The computer-readable storage medium of claim 15, wherein, to determine, for the particular candidate access control assignment, the over-privileging cost, the computer-executable instructions, when executed by the processor, further cause the processor to:
determine, for the particular access control assignment, a first over-privileging cost based on permissions and a resource scopes granted by the particular candidate access control assignment on a permanent basis, and the paired activity data; and
determine, for the particular access control assignment, a second over-privileging cost based on the permitted tasks and the resource scopes granted by the particular candidate access control assignment on an on-demand basis, and a frequency or pattern of task and resource pairs in the paired activity data;
wherein, to determine the set of recommended access control assignments, the computer-executable instructions, when executed by the processor, further cause the processor to: determine, based on the first over-privileging cost and the second over-privileging cost, that a recommended access control assignment of the set of recommended access control assignments should be assigned on at least one of a permanent basis or an on-demand basis.

18. The computer-readable storage medium of claim 17, wherein, to determine, for the particular access control assignment, the first over-privileging cost, the computer-executable instructions, when executed by the processor, further cause the processor to perform at least one of:
determine the first over-privileging cost based on a permission type of the permitted tasks granted by the particular candidate access control assignment;
determine the first over-privileging cost based on a data type of the resource scopes granted by the particular candidate access control assignment;
determine the first over-privileging cost based on a data size of the resource scopes granted by the particular candidate access control assignment; or
determine the first over-privileging cost based on a presence of task and resource pairs in the paired activity data that correspond to permissions and resource scopes granted by the particular candidate access control assignment.

19. The computer-readable storage medium of claim 17, wherein, to determine, for the particular access control assignment, the second over-privileging cost, the computer-executable instructions, when executed by the processor, further cause the processor to perform at least one of:
determine the second over-privileging cost based on a frequency of occurrence of task and resource pairs in the paired activity data that correspond to permissions and resource scopes granted by the particular candidate access control assignment; or
determine the second over-privileging cost based on a pattern of task and resource pairs in the paired activity data that correspond to permissions and resource scopes granted by the particular candidate access control assignment.

20. The computer-readable storage medium of claim 16, wherein, to perform the action, the computer-executable instructions, when executed by the processor, further cause the processor to perform at least one of:
provide, to a user, a recommendation to keep a current access control assignment currently assigned to the identity;
provide, to a user, a recommendation to reassign, on an on-demand basis, a current access control assignment currently assigned to the identity on a permanent basis;
provide, to a user, a recommendation to reassign, on a permanent basis, a current access control assignment currently assigned to the identity on an on-demand basis;
provide, to a user, a recommendation to replace a current access control assignment currently assigned to the identity with at least a portion of the set of recommended access control assignments on a permanent basis;
provide, to a user, a recommendation to assign a recommended access control assignment in the set of recommended access control assignments on a permanent basis;
provide, to a user, a recommendation to assign a recommended access control assignment in the set of recommended access control assignments to the identity on an on-demand basis;
automatically reassign, on an on-demand basis, a current access control assignment currently assigned to the identity on a permanent basis;
automatically reassign, on a permanent basis, a current access control assignment currently assigned to the identity on an on-demand basis;
automatically replace a current access control assignment currently assigned to the identity with at least a portion of the set of recommended access control assignments;
automatically assign a recommended access control assignment in the set of recommended access control assignments to the identity on a permanent basis; or
automatically assign a recommended access control assignment in the set of recommended access control assignments to the identity on an on-demand basis.
